(19) United States
(12) Patent Application Publication
(10) Pub. No.: US 2014/0063239 A1
(43) Pub. Date: Mar. 6, 2014

(54) AREA SURVEILLANCE SYSTEMS AND METHODS

(71) Applicant: Visualant, Inc., (US)

(72) Inventors: Thomas A. Furness, III, Seattle, WA (US); Brian T. Schowengerdt, Seattle, WA (US)

(73) Assignee: Visualant, Inc., Seattle, WA (US)

(21) Appl. No.: 13/762,095

(22) Filed: Feb. 7, 2013

Related U.S. Application Data
(60) Provisional application No. 61/597,586, filed on Feb. 10, 2012.

(51) Int. Cl. G01N 21/25; H04N 7/18

(52) U.S. Cl. CPC G01N 21/255; H04N 7/18
USPC 348/143

(57) ABSTRACT

A spectral analysis surveillance system includes sources or emitters which emit various wavelengths of electromagnetic radiation or energy into a space under surveillance, and a sensor which produce signals indicative of electromagnetic energy returned by people and other objects in the space. The electromagnetic radiation may fall in the visible portion of the electromagnetic spectrum yet the energy is emitted to appear as either white light or a single color. Returned energy is analyzed against reference samples. The spectral analysis surveillance system may be part of an integrated surveillance system including other components, for example metal detectors, baggage X-ray scanners, full body imagers, etc., and may provide surveillance of private or public locations, for instance airports.

### BACKGROUND

1. Technical Field

This disclosure relates to surveillance of areas, for instance indoor or outdoor public spaces or private spaces.

2. Description of the Related Art

Surveillance of public and private spaces is fast becoming the norm in the United States and throughout the World. For example, video cameras or closed circuit television (CCTV) are employed for surveillance in numerous public and private locations. Some examples of private spaces in which video or CCTV surveillance is employed include bank lobbies, convenience stores, commercial building lobbies, and casino gaming floors. Some examples of private spaces in which video or CCTV surveillance is employed include city streets, highways or tollbooths, lobbies of public buildings, airports, and train stations.

Such video surveillance typically takes two forms. In a passive form, video or other images of the space are captured and stored for later use. Such images are then available for later review should an event occur (e.g., robbery or other criminal activity) in which inspection of the video would prove useful. In an active form, security personnel may monitor in real time one or more displays of live video or images for suspicious or criminal activity. The passive form may have some deterrent effect on criminal activity, but is generally used to identify individuals after the fact. The active form may allow real time intervention to stop criminal activity, but requires a substantial investment in human resources and is typically limited by a human's visual perceptive abilities.

It may be useful to automatically identify and/or characterize various aspects of people and/or other objects in a space. It may also be useful to identify and/or characterize various aspects of people and/or other objects in a space based on characteristics which are not typically visually perceptible to humans, even humans who have been highly trained in surveillance techniques.

### BRIEF SUMMARY

Use of a surveillance system that detects responses from objects, such as people, luggage, and parcels, to various wavelengths of electromagnetic radiation and performs spectral analysis may allow enhanced surveillance of public and private spaces. Such may allow inspection and/or analysis of people, animals and/or other objects in a space. Such may allow performance of inspection and/or analysis using characteristics not normally visually perceptible to humans, even trained humans. For example, such may allow automation of inspection and/or analysis, for example using automated comparison or matching of responses against reference samples and specimens. A spectral analysis surveillance system may be combined with other forms of surveillance or security, for instance metal detection, X-ray, and other imaging techniques including RF backscatter full body scanners, air sampling (e.g., for nitrates), and swab analysis (e.g., for nitrates or oxidants), as well as physical inspections (e.g., individual pat downs, luggage inspection) and identity document (e.g., driver license, passport, identity card) authentication to realize a fully integrated surveillance system.

A spectral analysis surveillance system may be summarized as including a first set of a plurality of emitters positioned to emit electromagnetic energy into a space, the first set including a number of respective emitters for each of at least three wavelength bands of electromagnetic energy; at least a second set of a plurality of emitters positioned to emit electromagnetic energy into the space including a number of respective emitters for each of at least three wavelength bands of electromagnetic energy, the second set spaced from the first set; at least one sensor positioned to receive electromagnetic energy returned from any objects in the space and produce signals indicative of the received electromagnetic energy; and a control subsystem that correlates the signals indicative of the electromagnetic energy received by the at least one sensor with the emissions of electromagnetic energy produced by the emitters of the first and second sets, and wherein the emitters of the first and at least the second sets operate such that the emission of individual colors onto the objects in the space, if any, are imperceptible as individual colors by an unaided human eye.

The emission of individual colors onto the objects in the space, if any, may be perceptible as white light by the unaided human eye. The emitters of the first and at least the second sets may be operated at a frequency sufficiently high as to render the emission of individual colors onto the objects in the space, if any, imperceptible to the unaided human eye. The emitters of each of the bands may be controlled to emit at respective times such that only emission in a single one of the wavelength bands occurs at any respective time, and a frequency of operation renders the single wavelength band emissions imperceptible to the unaided human eye. The emitters of the first and at least the second sets may be operated in triplets, each triplet including at least one emitter of each of the at least three wavelength bands, and the combined emission of the triplets is perceptible as white light by the unaided human eye. Each triplet may be formed by two emitters from the first set and one emitter from the second set. The wavelength bands of electromagnetic energy of the first set may include a red band, a green band and a blue band. Each of the emitters may be operable to emit electromagnetic energy of a first wavelength at a first time and to emit electromagnetic energy in of a second wavelength at a second time, the second wavelength different than the first wavelengths and the first and the second wavelengths in the respective wavelength band of the emitter. A nominal wavelength of each of the wavelength bands of the emitters of the first set may be the same as a nominal wavelength of each respective one of the wavelength bands of the emitters of the second set. The first set of emitters may be carried by a first circuit board and the second set of emitters may be carried by a second circuit board, the second circuit board spaced from the first circuit board. The first set of emitters may be carried by a first circuit board and the second set of emitters may be carried by a second circuit board, the second circuit board spaced across at least a portion of the space from the first circuit board. The first set of emitters may be carried by a major face of a first circuit board and the second set of emitters may be carried by a major face of a second circuit board, the major face of the second circuit board angularly offset from the major face of the first circuit board such that a perpendicular axis to the major face of the second circuit board intersects with a perpendicular axis to the major face of the first circuit board. The spectral analysis surveillance system may further include at least a third set of a plurality of emitters positioned to emit electromagnetic energy into the space, the third set including a number of respective emitters for each of at least three wavelength bands of electromagnetic energy, the third set spaced from the first and the second sets, and wherein the control subsystem correlates the signals indicative of the electromagnetic energy received by the at least one sensor with the emissions of electromagnetic energy produced by the emitters of the third set and the emitters of at least the third set operate such that the emission of individual colors onto the objects in the space, if any, are imperceptible as individual colors by the unaided human eye. The space may be at least one of a room, an entry or corridor, defined by a number of walls, a ceiling and a floor and the emitters of at least one of the first or the second sets may be mounted to at least one of the walls, ceiling or floor.

A method of operating a spectral analysis surveillance system may be summarized as including operating a first set of a plurality of emitters to emit electromagnetic energy into a space, the first set including a number of respective emitters for each of at least three wavelength bands of electromagnetic energy;

operating at least a second set of a plurality of emitters to emit electromagnetic energy into the space including a number of respective emitters for each of at least three wavelength bands of electromagnetic energy, the second set spaced from the first set; sensing by at least one sensor electromagnetic energy returned from any objects in the space; producing by the at least one sensor signals indicative of the electromagnetic energy received by the least one sensor; and correlating by a control subsystem the signals indicative of the electromagnetic energy received by the at least one sensor with the emissions of electromagnetic energy produced by the emitters of the first and second sets, and wherein operating the first and at least the second sets may include operating the first and at least the second sets such that the emission of individual colors onto the objects in the space, if any, are imperceptible as individual colors by an unaided human eye.

Operating the first and at least the second sets may include operating the first and at least the second sets such that the emission of individual colors onto the objects in the space, if any, are perceptible as white light by the unaided human eye. Operating the first and at least the second sets may include operating the first and at least the second sets at a frequency sufficiently high as to render the emission of individual colors onto the objects in the space imperceptible to the unaided human eye. Operating the first and at least the second sets may include controlling the emitters to emit at respective times such that only emission in a single one of the wavelength bands occurs at a time, and a frequency of operation renders the single wavelength band emissions imperceptible to the unaided human eye. Operating the first and at least the second sets may include operating the emitters of the first and at least the second sets in triplets, each triplet including at least one emitter of each of the at least three wavelength bands, and the combined emission of at least half of the triplets is perceptible as white light by the unaided human eye. Operating the emitters of the first and at least the second sets in triplets may include selectively activating two emitters from the first set and one emitter from the second set as one of the triplets. Operating a first set of a plurality of emitters to emit electromagnetic energy into a space may include operating at least a first emitter of the first set to emit in a red band, operating at least a second emitter of the first set to emit in a green band and operating at least a third emitter of the first set to emit in a blue band. Operating the first and at least the second sets may include at respective times, supplying at least two different current levels to each of the emitters to cause the emitter to emit electromagnetic energy of at least two different wavelengths in the respective wavelength band of the emitter. Operating a first set of a plurality of emitters may include supplying at least one signal to a first circuit board which carries the first set of emitters and operating a second set of a plurality of emitters may include supplying at least one signal to a second circuit board which carries the second set of emitters. Operating a first set of a plurality of emitters may include supplying at least one signal to a first circuit board which carries the first set of emitters and operating a second set of a plurality of emitters may include supplying at least one signal to a second circuit board which carries the second set of emitters and which is spaced across at least a portion of the space from the first circuit board. Operating a first set of a plurality of emitters may include supplying at least one signal to a first circuit board which has a major face that carries the first set of emitters and operating a second set of a plurality of emitters may include supplying at least one signal to a second circuit board which has a major face that carries the second set of emitters, the major face of the second circuit board angularly offset from the major face of the first circuit board such that a perpendicular axis to the major face of the second circuit board intersects with a perpendicular axis to the major face of the first circuit board. The method may further include operating at least a third set of a plurality of emitters to emit electromagnetic energy into the space, the third set including a number of respective emitters for each of at least three wavelength bands of electromagnetic energy, the third set spaced from the first and the second sets, wherein operating the emitters of at least the third set may include operating the emitters of the third set such that the emission of individual colors onto the objects in the space, if any, are imperceptible as individual colors by the unaided human eye; and correlating by the control subsystem the signals indicative of the electromagnetic energy received by the at least one sensor with the emissions of electromagnetic energy produced by the emitters of the third set.

An integrated surveillance system may be summarized as including at least one spectral analysis surveillance system, comprising: a first set of a plurality of emitters positioned to emit electromagnetic energy into a space, the first set including a number of respective emitters for each of at least three wavelength bands of electromagnetic energy; at least a second set of a plurality of emitters positioned to emit electromagnetic energy into the space including a number of respective emitters for each of at least three wavelength bands of electromagnetic energy, the second set spaced from the first set; at least one sensor positioned to receive electromagnetic energy returned from any objects in the space and produce signals indicative of the received electromagnetic energy; and a control subsystem that correlates the signals indicative of the electromagnetic energy received by the at least one sensor with the emissions of electromagnetic energy produced by the emitters of the first and second sets, and wherein the emitters of the first and at least the second sets operate such that the emission of individual colors onto the objects in the space, if any, are imperceptible as individual colors by an unaided human eye; and at least one other surveillance system that does not emit electromagnetic energy in a visible portion of an electromagnetic spectrum.

The at least one other surveillance system may include at least one metal detector systems. The at least one other surveillance system may include at least one full body imaging system which emits electromagnetic energy in at least one of the radio or the microwave portions of the electromagnetic spectrum. The at least one other surveillance system may include at least one baggage screening which emits electromagnetic energy in at least one of the X-ray, radio or the microwave portions of the electromagnetic spectrum.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is an isometric view of an integrated surveillance system including a spectral analysis surveillance system installed to surveil a public or private space, according to one illustrated embodiment.

FIG. 1B is a front elevational view of an enlarged portion of a panel of the spectral analysis surveillance system of FIG. 1A, omitting any cover, showing a plurality of sources or emitters, according to one illustrated embodiment.

FIG. 2 is a schematic diagram of distributed integrated surveillance system including a number of distributed spectral analysis surveillance systems and other types of surveillance systems or devices distributed to surveil a plurality of spaces, according to one illustrated embodiment.

FIG. 3 is a partially broken front, right isometric view of a portion of a spectral analysis surveillance system showing a plurality of emitters thereof, according to one illustrated embodiment.

FIG. 4 is a partially broken front, right isometric view of a portion of a spectral analysis surveillance system showing a plurality of emitters and a spectral sensor thereof, according to another illustrated embodiment.

FIG. 5 is a schematic diagram showing a spectral analysis surveillance system, according to one illustrated embodiment.

FIG. 6 is a flow diagram showing a high level method of operating a spectral analysis surveillance system, according to one illustrated embodiment.

FIG. 7 is a flow diagram showing a low level method of operating a spectral analysis surveillance system by, in part, correlating sensed signals with wavelengths of emission, according to one illustrated embodiment, which may be useful in addition to the method of FIG. 6.

FIG. 8 is a flow diagram showing a low level method of operating a spectral analysis surveillance system by operating at frequencies which produce an appearance or perception of white light, according to one illustrated embodiment, which may be useful in performing part of the method of FIG. 6.

FIG. 9 is a flow diagram showing a low level method of operating a spectral analysis surveillance system by emitting distinct wavelengths at respective times while producing emissions perceptible as white light, according to one illustrated embodiment, which may be useful in performing part of the methods of FIGS. 6 and/or 7.

FIG. 10 is a flow diagram showing a low level method of operating a spectral analysis surveillance system by operating emitters from at least two different sets of emitters to produce emission perceptible as white light, according to one illustrated embodiment, which may be useful in performing part of the method of FIG. 6.

FIG. 11 is a flow diagram showing a low level method of operating a spectral analysis surveillance system by forming a triplet with emitters from two different sets of emitters, according to one illustrated embodiment, which may be useful in performing the method of FIG. 6.

FIG. 12 is a flow diagram showing a low level method of operating a spectral analysis surveillance system by forming a triplet including a red band emitter, a green band emitter and a blue band emitter, according to one illustrated embodiment, which may be useful in performing the methods of FIGS. 6 and/or 7.

FIG. 13 is a flow diagram showing a low level method of operating a spectral analysis surveillance system by supplying different current levels to a given emitters to vary a wavelength of emission of the emitter, according to one illustrated embodiment, which may be useful in performing the methods of FIGS. 6 and/or 7.

FIG. 14 is a flow diagram showing a low level method of operating a spectral analysis surveillance system by supplying signals to two different circuit boards, according to one illustrated embodiment, which may be useful in performing the methods of FIGS. 6 and/or 7.

FIG. 15 is a flow diagram showing a low level method of operating a spectral analysis surveillance system portion of an integrated surveillance system, according to one illustrated embodiment, which may be useful in performing the method of FIG. 6, for example in performing analysis.

FIG. 16 is a flow diagram showing a low level method of operating a spectral analysis surveillance system portion of an integrated surveillance system, according to one illustrated embodiment, which may be useful in performing the method of FIG. 15, for example in determining a degree, level or extent to which a match exists.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications, position determination, power production including rectification, conversion and/or conditioning, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

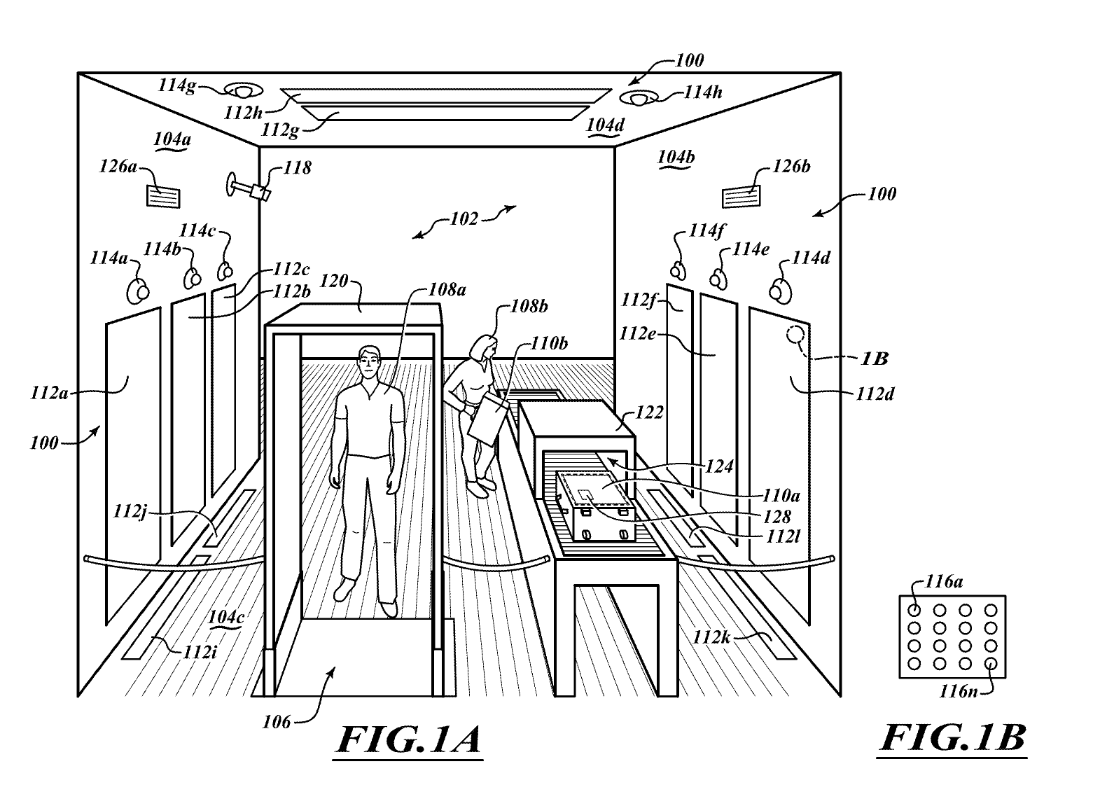

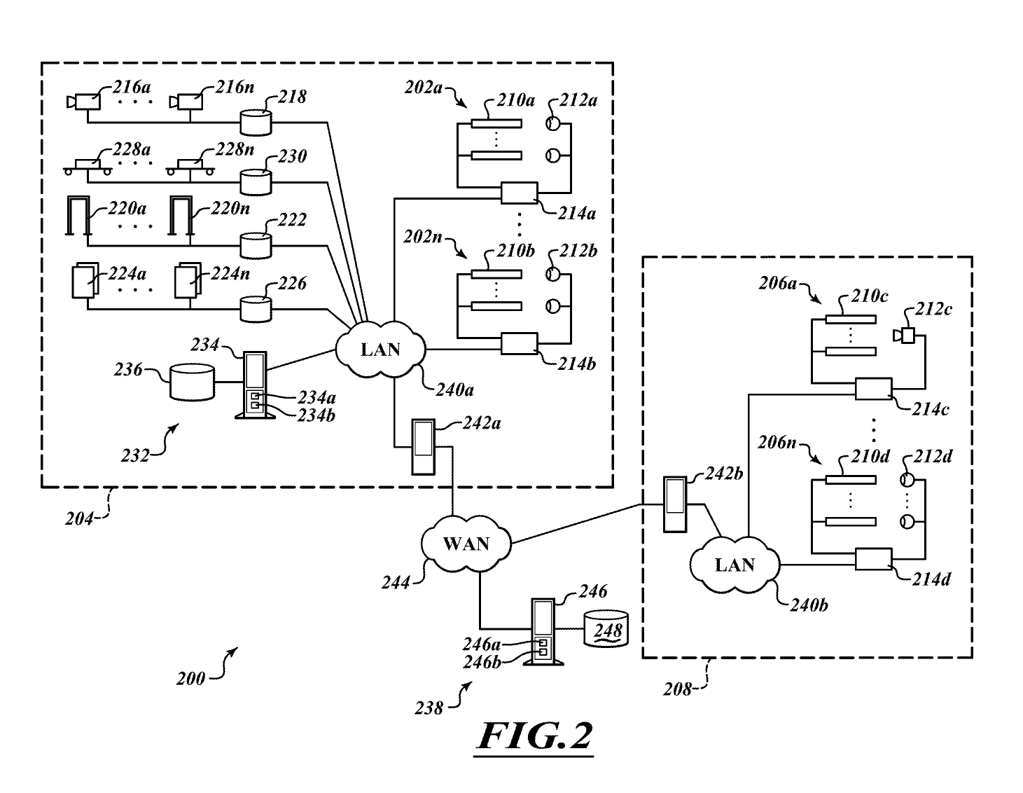

The headings and Abstract of the Disclosure provided herein are for convenience only and do not interpret the scope or meaning of the embodiments. FIG. 1A shows an integrated surveillance system 100 installed to surveil a space 102, according to one illustrated embodiment.

The space 102 may be a private space owned or controlled by a non-government entity such as a business or corporation. Examples of private spaces include, but are not limited to, bank lobbies, convenience stores, commercial building lobbies, and casino gaming floors. The space 102 may be a public space owned or controlled by a government entity such as a city, state, public commission or country business or corporation. Examples of public spaces include, but are not limited to, city streets, highways or tollbooths, lobbies of public buildings, airports, and train stations. The space 102 may be a combination of private and public space, and the precise characterization of the type of space should not be considered limiting of the claimed subject matter.

The space 102 may be delimited by one or more structures, such as walls 104a, 104b, floor 104c, ceiling 104d, barricades (not shown), fences (not shown), barriers (not shown), etc., or may be not be delimited. In many instances surveillance will be optimized by use of controlled access delimited spaces 106, particularly where all people and other objects must pass through a defined gateway, portal or channel such as a doorway or corridor. An example of such a controlled access delimited space are the security screening areas commonly found at airports, through which all persons accessing aircraft must pass. Similar such screening areas are also found in many public buildings (e.g., U.S. Capitol) and monuments (e.g., Statute of Liberty).

The space 102 may be occupied by one or more people 108a, 108b (collectively 108, only two shown), other animals (not shown) and/or other objects 110a, 110b (collectively 110, only two shown). The objects may take a large variety of forms, for example inanimate objects, for instance luggage, bags, parcels, bundles, shoes, outer garments, to name just a few of the most common. In most situations the people 108 and/or other objects 110 are transient, passing through the space 102, although such may not necessarily be the case in all situations.

As illustrated in FIG. 1A, the integrated surveillance system 100 includes a spectral analysis surveillance system 111. The spectral analysis surveillance system 111 may include one or more arrays of emitters 112a-112l (collectively 112, twelve shown) operable to emit electromagnetic radiation at various wavelengths, and one or more sensors 114a-114h (collectively 114, eight shown) responsive to electromagnetic energy returned from people 108 or other objects 110 in the space 102. FIG. 1B shows a portion of one array of emitters 112a, enlarged and without any cover, illustrating individual emitters 116a-116n (collectively 116, sixteen shown, only two called out in FIG. 1B). The emitters 116 of the arrays of emitters 112 may be arranged in either an ordered array as illustrated, or in an unordered array (not shown).

The arrays of emitters 112 may be mounted or carried by one or more structures. For example, arrays of emitters 112a-112f may be mounted or carried on opposing walls 104a, 104b delimiting the space 102. Additionally, or alternatively, arrays of emitters 112g, 112h may be mounted or carried on a portion of the ceiling 104d. Additionally, or alternatively, arrays of emitters 112i-112l may be mounted or carried on a portion of the floor 104c. While illustrated on either side of a pathway, the arrays of emitters 112i-112l on the floor 104c may in some cases be located directly under the pathway, particularly where the floor 104c or portion thereof is formed of a strong material that is transparent or at least translucent to the particular wavelengths of interest. In some instances, the arrays of emitters 112 may be mounted to freestanding structures such as stanchions, pedestals, barriers, barricades or screens.

The sensors 114 may be mounted or carried by one or more structures. For example, sensors 114a-114f may be mounted or carried on opposing walls 104a, 104b which delimit the space 102. Additionally, or alternatively, sensors 104g, 104h may be mounted or carried on a portion of the ceiling 104d. Additionally, or alternatively, sensors (not shown) may be mounted or carried on a portion of the floor 104c. In some instances, the sensors may be mounted to freestanding structures such as stanchions, pedestals, barriers, barricades or screens.

Other surveillance devices or systems in addition to the spectral analysis surveillance system may be positioned to surveil the space 102, and may be part of the integrated surveillance system 100.

For example, a number of cameras 118 (only one shown), for instance digital still or analog or digital video cameras may be positioned to provide surveillance images of the space 102. The cameras 118 may have a fixed field of view, or may have an adjustable field of view. For instance, one or more of the cameras 118 may be mounted for movement, such as rotation about one or more axes. An actuator such as an electric motor may be remotely operated to change or adjust the field of view of the camera 118. While illustrated as exposed, the cameras 118 may be unobtrusively placed or hidden from view, for instance behind a mirror or mask that is generally opaque to a human observer but transparent or at least translucent to certain wavelengths of interest. The cameras 118 may be wired or wireless and communicatively coupled to a back office system or server, for instance as described in reference to FIG. 2 below.

Images from the cameras 118 may be monitored manually by trained individuals and/or monitored automatically using a programmed computer or other apparatus that detects the occurrence of certain events or of certain physical characteristics. For instance, a computer may execute pattern recognition software. The pattern recognition software may cause the computer to detect the occurrence of an event such as an appearance of a person 108 or other object 110 in an unauthorized area, or suspicious movement of a person 108, for instance moving above a threshold speed or movement away from security personnel. The pattern recognition software may cause the computer to detect the appearance of an object 110 such as an unaccompanied bag, parcel or piece of luggage. The pattern recognition software may cause the computer to detect the appearance of a person 108 in the space 102 with facial or other physical bodily characteristics matching those stored in a database. In recognizing one or more of the above, the pattern recognition software may analyze a single image of the space, or may compare sequential images of the space for instance to automatically detect the appearance or even the disappearance of a person 108 or other object 110 from the space 102, or to detect the movement, and/or rate of movement or direction of movement of a person 108 or other object 110 in the space 102.

The cameras 118 may constitute a standalone system completely independent from the spectral analysis surveillance system 111 and/or integrated surveillance system 100. Alternatively, the cameras 118 may be communicatively coupled to the spectral analysis surveillance system 111 as part of the integrated surveillance system 100, or to some surveillance system to which the spectral analysis surveillance system 111 is also communicatively coupled and which employs information or data from both the spectral analysis surveillance system 111 and at least the cameras 118 in performing analysis. As a further alternative, the same devices may be used as both the sensors of the spectral analysis surveillance system 111 and to acquire images (e.g., video images) for the manual and/or automatic analysis discussed in the paragraph immediately above.

Also for example, an individual inspection system 120 may be located in a controlled access delimited space 106 (e.g., passageways or lanes) to provide scanning of each person 108 passing through the space 102. The individual inspection system 120 may take a variety of forms. For example, the individual inspection system 120 may take the form of a metal detector. Additionally, or alternatively, the individual inspection system 120 may take the form of a full body RF backscatter imaging system or other scanner or imager.

While only a single individual inspection system 120 is illustrated, in practice there may be multiple controlled access delimited spaces 106, each associated with a respective one or more individual inspection systems 120.

The individual inspection system 120 may constitute a standalone system completely independent from the spectral analysis surveillance system 111 or integrated surveillance system 100. Alternatively, the individual inspection system 120 may be communicatively coupled to the spectral analysis surveillance system 111 as part of the integrated surveillance system 100, or to some surveillance system to which the spectral analysis surveillance system 100 is also communicatively coupled and which employs information or data from both the spectral analysis surveillance system 100 and at least the individual inspection system 120 in performing analysis.

As yet another example, a baggage or package inspection system 122 may be located in a controlled access delimited space 124 (e.g., passageways or lanes) to provide scanning of each piece of baggage, package or other object 110 passing through the space 102. The baggage or package inspection system 122 may take a variety of forms. For example, the baggage or package inspection system 122 may take an X-ray or other imaging system. Additionally, or alternatively, the baggage or package inspection system 122 may take the form of a metal detector. While only a single baggage or package inspection system 122 is illustrated, in practice there may be multiple controlled access delimited spaces 124, each associated with a respective one or more baggage or package inspection system 122.

The baggage or package inspection system 122 may constitute a standalone system completely independent from the spectral analysis surveillance system 100 or integrated surveillance system 100. Alternatively, the baggage or package inspection system 122 may be communicatively coupled to the spectral analysis surveillance system 100 as part of the integrated surveillance system 100, or to some surveillance system to which the spectral analysis surveillance system 100 is also communicatively coupled and which employs information or data from both the spectral analysis surveillance system 100 and at least the baggage or package inspection system 122 in performing analysis.

As yet a further example, an air sensor system 126a, 126b (collectively 126, only two shown) may include one or more sensors to sense or otherwise detect the presence and/or absence of certain substances in the air in the space 102. For example, one or more sensors may be positioned to sense or otherwise detect a presence of chemicals associated with explosives or other contraband.

The individual inspection system 120 may constitute a standalone system completely independent from the spectral analysis surveillance system 111 or integrated surveillance system 100.

The air sensor system 126 may constitute a standalone system completely independent from the spectral analysis surveillance system 100 or integrated surveillance system 100. Alternatively, the air sensor system 126 may be communicatively coupled to the spectral analysis surveillance system 100 as part of the integrated surveillance system 100, or to some surveillance system to which the spectral analysis surveillance system 100 is also communicatively coupled and which employs information or data from both the spectral analysis surveillance system 100 and at least the air sensor system 126 in performing analysis.

As still a further example, swabs 128 may be employed to sample various surfaces for the presence of certain substances such as chemicals (e.g., nitrates, oxidants) associated with explosives or other contraband. The swabs 128 may automatically perform the analysis for the substance, for example using one or more reagents present on the swab or applied directly thereto for instance in response to removing the swab 128 from a package or removing a release liner. Alternatively, the swabs 128 may be analyzed using various pieces of analytical equipment (not shown), for instance gas chromatographs, mass spectrometers and/or lab-on-a-chip systems. This analytical equipment may be communicatively coupled to form part of the integrated surveillance system 100.

As noted above, these other surveillance devices or systems may be standalone devices or may be integrated into an overall surveillance system with one or more of the multispectral surveillance devices or systems, for example as described below with reference to FIG. 2.

FIG. 2 shows an integrated surveillance system 200 according to one illustrated embodiment.

The surveillance system 200 may include a first number of spectral analysis surveillance systems 202a-202n at a first location 204 and a second number of spectral analysis surveillance systems 206a-206n at a second location 208 different from the first location 204. The locations 204, 208 may be different facilities, for example respective ones of two or more public buildings or other public infrastructure. The locations 204, 208 may be respective ones of two or more portions of a single facility such as two or more terminals or two or more passenger screening areas at an airport.

Each of the spectral analysis surveillance systems 202, 206 may include one or more sets or arrays of emitters 210a-210d (collectively 210, eight shown, only four called out in FIG. 2) operable to emit electromagnetic radiation at a variety of wavelengths in a space. Each of the spectral analysis surveillance systems 202, 206 may include one or more sensors 212a-212d (collectively 212, seven shown, only four called out in FIG. 2) responsive to electromagnetic radiation at one or more wavelengths returned from people or objects in the space. Each of the spectral analysis surveillance systems 202, 206 may include one or more control subsystems 214a-214d (collectively 214, four shown) communicatively coupled and operable to control the emitters 210 and to at least correlate electromagnetic radiation sensed or otherwise detected by the sensors 212 with the emitted wavelengths. In some instances, the control subsystems 214 may also process sensed information using the correlations, for example as described below.

One or more of the locations 204, 208 may include additional surveillance systems or devices.

For example, a first location 204 may include multiple cameras 216a-216n (collectively 216). The cameras 216 may be similar, or even identical, to the cameras 118 (FIG. 1A). The cameras 216 are operable to capture images of one or more spaces under surveillance. As previously noted, the cameras 216 may have either a fixed or an adjustable field of view. The cameras 216 may be communicatively coupled to a local image storage device 218 (e.g., nontransitory computer-readable media).

Also for example, the first location 204 may include multiple metal detectors 220a-220n (collectively 220). The metal detectors 220 may be similar, or even identical, to the individual inspection system 120 (FIG. 1A). For example, the metal detectors 220 may be walkthrough style metal detectors commonly found at airports and entrances of some public buildings and monuments. The metal detectors 220 may be communicatively coupled to a local metal detection information storage device 222 (e.g., nontransitory computer-readable media).

Also for example, the first location 204 may include multiple individual or body imaging or scanning systems 224a-224n (collectively 224). The body imaging systems 224 may be similar, or even identical, to the individual inspection system 120 (FIG. 1A). For example, body imaging systems 224 may take the form of backscatter RF full body imaging systems commonly found at airports. The body imaging systems 224 may be communicatively coupled to a local individual imaging system information storage device 226 (e.g., nontransitory computer-readable media).

Also for example, the first location 204 may include multiple baggage or package inspection systems 228a-228n (collectively 228). The baggage or package inspection systems 228 may be similar, or even identical, to the baggage or package inspection system 122 (FIG. 1A). For example, baggage or package inspection systems 228 may take the form of X-ray based imaging systems commonly found at airports. The baggage or package inspection systems 228 may be communicatively coupled to a local baggage imaging system information storage device 230 (e.g., nontransitory computer-readable media).

The first location 204 may include a local control system 232 communicatively coupled and configured to control operation of the various surveillance components at the first location 204. The local control system 232 may include one or more computing systems 234, each with one or more associated processors 234a and nontransitory computer- or processor-readable memory or storage device 234b. The local control system 232 may also include a nontransitory storage device 236 to store collected information in a computer- or processor-readable form. Such may be stored in a structured manner, for example in a table, spreadsheet or relational database.

In contrast, the second location may rely on remotely located control, for example via a remotely located back office control system 238, as described below.

The various components at the first location 204 may be communicatively coupled, for example communicatively coupled via one or more communications networks, for instance by a first local area network (LAN) 240a. The various components at the second location 208 may be communicatively coupled, for example communicatively coupled via one or more communications networks, for instance by a second local area network (LAN) 240b.

The first and the second locations 204, 208 may each include one or more servers 242a, 242b or other computers that provide networked communications with systems external from the respective locations. For example, the servers 242a, 242b may provide communications with the back office control system 238, remotely located from one or more of the locations 204, 208. Communications may, for example be provided via a wide area network (WAN) 244. In most instances, the communications will be secured, employing an extranet and/or encryption and authentication procedures.

The back office control system 238 may include one or more computing systems 246, each with one or more associated processors 246a and nontransitory computer- or processor-readable memory or storage devices 246b. The back office control system 238 may also include a nontransitory storage device 248 to store collected information in a computer- or processor-readable form. Such may be stored in a structured manner, for example in a table, spreadsheet or relational database.

The back office control system 238 may coordinate between the surveillance components at the various locations 204, 208. For example, the back office control system 238 may identify the occurrence of similar patterns occurring at different locations 204, 208. For instance, the back office control system 238 may recognize similar attempts to breach security at two or more different locations 204, 208. Such attempts may occur concurrently, or may occur sequentially in time. The back office control system 238 may serve as a “central” depository for information, for instance names and/or physical bodily characteristics including images of specific individuals that are of interest. Also for example, the back office control system 238 may implement “centralized” distribution of software or firmware updates, ensuring that all components will operate in an expected manner. As a further example, the back office control system 238 may implement “centralized” monitoring of an operational status of all system components, ensuring that all components are operating in an expected manner.

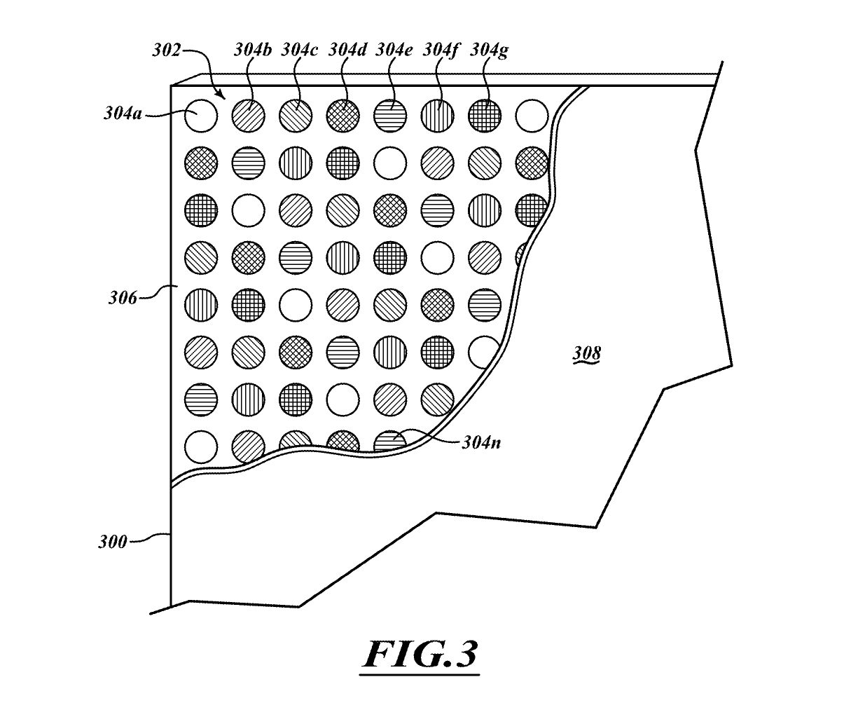

FIG. 3 shows an emission device 300 which is a portion of a spectral analysis surveillance system, according to one illustrated embodiment.

The emission device 300 of the spectral analysis surveillance system includes an array of emitters 302 including a plurality of emitters 304a-304n (collectively 304). The emitters are selectively operable to emit electromagnetic energy in a number of bands of wavelengths at a number of different wavelengths. The emitters may take a variety of forms, for example various types of light emitting diodes (LEDs) including organic LEDs (OLEDs) and/or laser LEDs. OLEDs may advantageously allow production of a flexible emission device 300. Other forms of emitters may be employed, for example other forms of lasers or other light sources. The lasers may, or may not, be tunable lasers. Alternatively, or additionally, the emitters 304 may take the form of one or more incandescent sources such as conventional or halogen light bulbs.

One, more or all of the emitters 304 may be operable to emit in part or all of an “optical” portion of the electromagnetic spectrum, including the (human) visible portion, near infrared portion and/or near ultraviolet portions of the electromagnetic spectrum. Additionally, or alternatively, the emitters 304 may be operable to emit electromagnetic energy from other portions of the electromagnetic spectrum, for example the infrared, ultraviolet and/or microwave portions.

For example, one or more emitters 304 may emit in a band centered around 450 nm, while one or more of the emitters 304 may emit in a band centered around 500 nm, while a further emitter or emitters may emit in a band centered around 550 nm. In some embodiments, each emitter 304 emits in a band centered around a respective frequency or wavelength, different than each of the other emitters 304. Using emitters 304 with different band centers advantageously maximizes the number of distinct samples that may be captured from a fixed number of emitters 304. This may be particularly advantageous where the emission device 300 is relatively small, and has limited space or footprint for the emitters 304. As an example, a first number of the emitters (e.g., emitters with same pattern as emitter marked as 304a) may be operable to emit at one, two or more wavelengths in a first band. For instance, each of those emitters 304a may be selectively operated to emit at two different wavelengths in the red band of visible light. The emitters 304a may emit at a first wavelength when driven by a first signal, for example a first current level or magnitude. The emitters 304a may emit at a second wavelength when driven by a second signal different from the first signal, for example a second current level or magnitude.

Also as an example, a second number of the emitters (e.g., emitters with same pattern as emitter marked as 304b) may be operable to emit at one, two or more wavelengths in a second band. For instance, each of those emitters 304b may be selectively operated to emit at two different wavelengths in the green band of visible light. The emitters 304b may emit at a first wavelength when driven by a first signal, for example a first current level or magnitude. The emitters 304b may emit at a second wavelength when driven by a second signal different from the first signal, for example a second current level or magnitude.

Further as an example, a third number of the emitters (e.g., emitters with same pattern as emitter marked as 304c) may be operable to emit at one, two or more wavelengths in a third band. For instance, each of those emitters 304c may be selectively operated to emit at two different wavelengths in the blue band of visible light. The emitters 304c may emit at a first wavelength when driven by a first signal, for example a first current level or magnitude. The emitters 304c may emit at a second wavelength when driven by a second signal different from the first signal, for example a second current level or magnitude.

Even further as an example, a fourth number of the emitters (e.g., emitters with same pattern as emitter marked as 304d) may be operable to emit at one, two or more wavelengths in a fourth band. For instance, each of those emitters 304d may be selectively operated to emit at two different wavelengths in the infrared (IR) or near-infrared (NIR) band of light. The emitters 304d may emit at a first wavelength when driven by a first signal, for example a first current level or magnitude. The emitters 304d may emit at a second wavelength when driven by a second signal different from the first signal, for example a second current level or magnitude.

Yet further as an example, a fifth number of the emitters (e.g., emitters with same pattern as emitter marked as 304e) may be operable to emit at one, two or more wavelengths in a fourth band. For instance, each of those emitters 304e may be selectively operated to emit at two different wavelengths in the ultraviolet (UV) or near-ultraviolet (NUV) band of light. The emitters 304e may emit at a first wavelength when driven by a first signal, for example a first current level or magnitude. The emitters 304e may emit at a second wavelength when driven by a second signal different from the first signal, for example a second current level or magnitude.

The emitters may have nominal wavelengths at which emission is expected to occur. However, the actual wavelengths of emission may vary from the nominal wavelengths for a variety of reasons, for example due to variation in temperature and/or variation between actual drive signal characteristics (e.g., current level) and nominal drive signal characteristics. Even with temperature compensation and other precautions there may be some variance between the actual and nominal wavelengths of emission. Thus, as used herein and in the claims, references to wavelength refer to nominal wavelengths. Also, while commonly identifiable bands have been given as examples, other bands may be employed. The bands may have any size bandwidth.

The distribution of spectral content for each emitter 304 may vary as a function of drive level (e.g., current, voltage, duty cycle), temperature, and other environmental factors, depending on the specific emitter 304. Such variation may be advantageously actively employed to operate one or more of the physical emitters 304 (also referred to as sources) as a plurality of “logical emitters,” each of the logical emitters operable to provide a respective emission spectra from a respective physical emitter 304. Thus, for example, the center of the band of emission for each emitter 304 may vary according to a drive level and/or temperature. For example, the center of the band of emission for LEDs will vary with drive current or temperature. One way the spectral content can vary is that the peak wavelength can shift. However, the width of the band, the skew of the distribution, the kurtosis, etc., can also vary. Such variations may also be advantageously employed to operate the physical emitters 304 as a plurality of logical emitters. Thus, even if the peak wavelength were to remain constant, the changes in bandwidth, skew, kurtosis, and any other change in the spectrum can provide useful variations in the operation of the emission device 300. Likewise, the center of the band of emission may be varied for tunable lasers. Varying the center of emission bands for one or more emitters 304 advantageously maximizes the number of samples that may be captured from a fixed number of emitters 304. Again, this may be particularly advantageous where the emission device 300 is relatively small, and has limited space or footprint for the emitters 304.

As illustrated the emitters 304 may be carried by a substrate 306. The substrate may take any of a large variety of forms, but most often will take the form of a circuit board or printed circuit board (PCB). The emitters 304 may be mounted to the substrate by any known technique, for example soldering, bump arrays, flip chip fashion, etc.

The emitters 304 may be arranged in an ordered array, for example a two-dimensional array as illustrated or in circles or groups of three forming triangles, or groups of more forming other geometric shapes. Alternatively, the emitters 304 may be arranged in an unordered array having no discernable pattern. The emitters 304 may be arranged in a repeating pattern based on the nominal wavelength of emission. For example, the emitters may be arranged as illustrated in FIG. 3, where emitters 304 of seven different nominal wavelengths are arranged sequentially along a row, the pattern of seven wavelengths repeating along each row. Likewise, the emitters 304 of seven different nominal wavelengths are arranged sequentially along a column, the pattern of seven wavelengths repeating along each column. Other arrangements are possible. For example, emitters 304 for each of three respective wavelengths may be grouped in sets of three, for instance arranged in triangular patterns. These triangular patterns may be repeated along rows and/or columns. Other groups of three emitters 304 of different wavelengths from the first, may be interposed between the other groups along each row or column. Emitters 304 may be arranged to achieve a relatively even distribution by wavelength over any unit area of the array.

A field of emission of one or more emitters 304 may be movable with respect to the substrate 306. For example, one or more emitters 304 may be movable mounted with respect to the substrate 306 or some other structure, such as mounted for translation along one or more axes, and/or mounted for rotation or oscillation about one or more axes. Alternatively, or additionally, the emission device 300 may include one or more elements operable to deflect or otherwise position the emitted electromagnetic energy. The elements may, for example, include one or more optical elements, for example lens assemblies, mirrors, prisms, diffraction gratings, etc. For example, the optical elements may include an oscillating mirror, rotating polygonal mirror or prism, or MEMS micro-mirror that oscillates about one or more axes. The elements may, for example, include one or more other elements, for example permanent magnets or electromagnets such as those associated with cathode ray tubes and/or mass spectrometers.

The emission device 300 of the spectral analysis surveillance system may optionally include a cover 308. The cover 308 may provide environmental protection to the emitters 304. The cover 308 is transparent or at least translucent to certain wavelengths of interest, for example the wavelengths emitted by the emitters 304. The cover 308 may hide the view of the emitters 304 from people located in the space 102 (FIG. 1A) that is under surveillance. The cover may take the form of one or more layers of glass (e.g., Gorilla Glass®), polymers (e.g., acrylic), optical filters, and/or tints or colored gels. The cover 208 may, for example, have a smoky appearance or mirrored appearance.

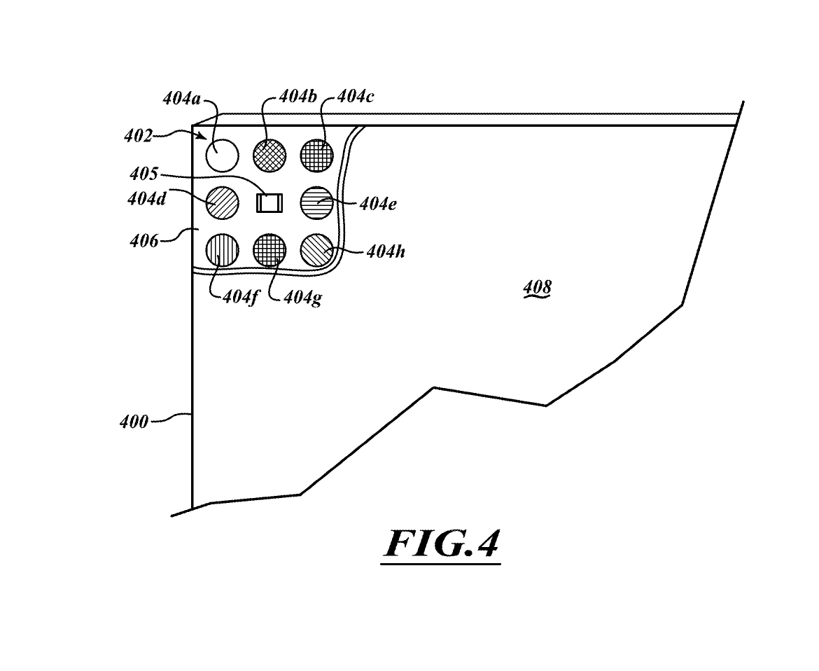

FIG. 4 shows an electromagnetic transducer device 400 which is a portion of a spectral analysis surveillance system, according to one illustrated embodiment.

The electromagnetic transducer device 400 includes an array of emitters 402 including a plurality of emitters 404a-404n (collectively 404) and a number of sensors 405 (only one shown).

The electromagnetic transducer device 400 is similar or even identical in many respects to the spectral emission device 300 (FIG. 3). For example, the emitters 404 may be carried by, or mounted to a substrate 406, and the electromagnetic transducer device 400 may include a cover 408. Description of similar or identical aspects is not repeated here in the interest of brevity. Only significant differences are discussed below.

The electromagnetic sensor 405 can take a variety of forms suitable for sensing or responding to electromagnetic energy. For example, the electromagnetic sensor 405 may take the form of one or more photodiodes (e.g., germanium photodiodes, silicon photodiodes). Alternatively, or additionally, the electromagnetic sensor 405 may take the form of one or more photomultiplier tubes. Alternatively, or additionally, the electromagnetic sensor 405 may take the form of one or more CMOS image sensors. Alternatively, or additionally, the spectral sensor 405 may take the form of one or more charge coupled devices (CCDs). Alternatively, or additionally the electromagnetic sensor 405 may take the form of one or more micro-channel plates. Other forms of electromagnetic sensors may be employed, which are suitable to detect the wavelengths expected to be returned in response to the particular illumination and properties of the object being illuminated.

The electromagnetic sensor 405 may be formed as individual elements, a one-dimensional array of elements and/or a two-dimensional array of elements. For example, the electromagnetic sensor 405 may be formed by one germanium photodiode and one silicon photodiode, each having differing spectral sensitivities. The electromagnetic transducer device 400 may employ a number of photodiodes with identical spectral sensitivities, with different colored filters (e.g., gel filters, dichroic filters, thin-film filters, etc.) over the photodiodes to change their spectral sensitivity. This may provide a simple, low-cost approach for creating a set of sensors with different spectral sensitivities, particularly since germanium photodiodes are currently significantly more expensive that silicon photodiodes. Also for example, the electromagnetic sensor 405 may be formed from one CCD array (one-dimensional or two-dimensional) and one or more photodiodes (e.g., germanium photodiodes and/or silicon photodiodes). For example, the electromagnetic sensor 405 may be formed as a one- or two-dimensional array of photodiodes. A two-dimensional array of photodiodes enables very fast capture rate (i.e., camera speed) and may be particularly suited to use in assembly lines or high speed sorting operations. For example, the electromagnetic sensor 405 may be formed as a one- or two-dimensional array of photomultipliers. Combinations of the above elements may also be employed.

In some embodiments, the electromagnetic sensor 405 may be a broadband sensor sensitive or responsive over a broad band of wavelengths of electromagnetic energy. In some embodiments, the electromagnetic sensor 405 may be a narrowband sensor sensitive or responsive over a narrow band of wavelengths of electromagnetic energy. In some embodiments, the electromagnetic sensor 405 may take the form of several sensor elements, as least some of the sensor elements sensitive or responsive to one narrow band of wavelengths, while other sensor elements are sensitive or responsive to a different narrow band of wavelengths. This approach may advantageously increase the number of samples that may be acquired using a fixed number of sources. In such embodiments the narrow bands may, or may not, overlap.

A field of view of the electromagnetic sensor 405 or one or more elements of the electromagnetic sensor 405 may be movable with respect to the substrate 406. For example, one or more elements of the electromagnetic sensor 405 may be movably mounted with respect to the substrate 406 or other structure, such as mounted for translation along one or more axes, and/or mounted for rotation or oscillation about one or more axes. Alternatively, or additionally, the electromagnetic transducer device 400 may include one or more elements operable to deflect or otherwise position the returned electromagnetic energy. The elements may, for example, include one or more optical elements, for example lens assemblies, mirrors, prisms, diffraction gratings, etc. For example, the optical elements may include an oscillating mirror, rotating polygonal mirror or prism, or MEMS micro-mirror that oscillates about one or more axes. The elements may, for example, include one or more other elements, example permanent magnets or electromagnets such as those associated with cathode ray tubes and/or mass spectrometers.

In some embodiments, the emitters 404 may also serve as the electromagnetic sensor 405. For example, an LED may be operated to emit electromagnetic energy at one time, and detect returned electromagnetic energy at another time. For example, the LED may be switched from operating as a source to operating as a detector by reverse biasing the LED. Also for example, an LED may be operated to emit electromagnetic energy at one time, and detect returned electromagnetic energy at the same time.

FIG. 5 shows a spectral analysis surveillance system 500, according to one illustrated embodiment. The spectral analysis surveillance system 500 may be a standalone system or may form a portion of an integrated surveillance system.

The spectral analysis surveillance system 500 includes a number of sources or emitters D₁, D₂, . . . , D_{N} (only eighteen shown and only three called out) which are operable to emit electromagnetic radiation at a variety of different wavelengths. As discussed herein, any one, more or all of the sources or emitters D₁, D₂, . . . , D_{N} may be operable to respectively emit electromagnetic radiation at two or more wavelengths, for example in response to different drive currents and/or different temperatures. Some examples of suitable sources or emitters D₁, D₂, . . . , D_{N} have been previously described.

The sources or emitters D₁, D₂, . . . , D_{N} may, for example, be organized in groups, sets or channels 502a, 502b, 502c (only three groups, sets or channels illustrated). For instance, sources or emitters D₁ that emit at various red wavelengths may be organized in a first group, set or channel 502a, emitters D₂ that emit at various blue wavelengths may be organized in a second group, set or channel 502b, and emitters D_{N} that emit at various green wavelengths may be organized in a third group, set or channel 502c. While illustrated in spatially separate or distinct groups, sets or channels 502a, 502b, 502c of the sources or emitters D₁, D₂, . . . , D_{N} of the different groups, sets or channels 502a, 502b, 502c may be spatially intermingled with one another.

The sources or emitters D₁, D₂, . . . , D_{N} are driven by adjustable drive current, which may be generated or supplied from one or more programmable current sources or current sinks 504a, 504b, 504c (only three illustrated, collectively 504). For example, a respective current source 504a, 504b, 504c may supply an adjustable drive current level to the sources or emitters D₁, D₂, . . . , D_{N} of the respective groups, sets or channels 502a, 502b, 502c, for instance as illustrated in FIG. 5. The sources or emitters D₁, D₂, . . . , D_{N} of each group, set or channel 502a, 502b, 502c may be coupled to ground via respective resistors R₁, R₂, R₃.

Each of the current sources 504 is operable to supply an adjustable level of current in response to a digital signal. Each current source 504 may include a voltage source 506 (only one called out in FIG. 5), a digital-to-analog (DAC) converter 508 (only one called out in FIG. 5) and an operational amplifier 510. The voltage source 506 provides a constant voltage to at least the DAC 508. The DAC 508 receives input signals, for instance a serial data input signal IN, a serial clock signal CLK and a synchronization signal SYNC. The DAC 508 is coupled to drive an input (e.g., noninverting pin) of the operational amplifier 510. The other input (e.g., noninverting pin) of the operational amplifier 510 may receive a reference signal REF, for example from a voltage divider resistor network (not illustrated), which will typically include a feedback path from an output of the operational amplifier 510. The operational amplifier 510 is responsive to the DAC 508 to provide the adjustable drive current to drive the sources or emitters D₁, D₂, . . . D_{N}. A suitable voltage source 506 may, for example, include the voltage reference device commercially available from Analog Devices under product designation ADR445. A suitable DAC 508 may, for example, include the nanoDAC® commercially available from Analog Devices under product designation AD5621. Suitable operational amplifiers 510 may, for example, include those commercially available from Analog Devices under product designations OP37 and AD711.

The spectral analysis surveillance system 500 may include one or more multiplexers MUX₁, MUX₂, MUX₃ to couple the drive current to selected ones of the sources or emitters D₁, D₂, . . . D_{N}. The multiplexers MUX₁, MUX₂, MUX₃ may be responsive to respective control signals C₁, C₂, C₃ to steer the drive current to selected sources or emitters D₁, D₂, . . . D_{N} to produce emission in a defined sequence of wavelengths, and optionally at a defined sequence of magnitudes.

The spectral analysis surveillance system 500 may employ other numbers of sources or emitters D₁, D₂, . . . D_{N}, current sources or sinks 504, and/or multiplexers MUX₁, MUX₂, MUX₃, as well as other arrangements of such components to implement an LED control subsystem 512. For example, the LED control subsystem 512 may omit the multiplexers MUX₁, MUX₂, MUX₃. Also for example, the LED control subsystem 512 may employ one or more power transistors (e.g., MOSFETs, IGBTs) to supply drive current to the emitters D₁, D₂, . . . D_{N}. The LED control subsystem 512 may, for example, take the form of, or include, a programmable logic controller (PLC), programmable gate array (PGA), application specific integrated circuit (ASIC), microcontroller, microprocessor, digital signal processor (DSP), and/or programmable system on chip (PSOC), and/or associated non-transitory storage media (e.g., memory). The LED control subsystem 512 may be configured to control when one or more sources or emitters D₁, D₂, . . . D_{N} is driven to emit, how long the sources or emitters D₁, D₂, . . . D_{N} are driven to emit, the wavelength at which the sources or emitters D₁, D₂, . . . D_{N} are driven to emit, a magnitude or intensity at which the sources or emitters D₁, D₂, . . . D_{N} emit, and/or any impose any form of modulation that is desired in or on a sequence of wavelengths or emissions. Thus, the LED control subsystem 512 may cause the sources or emitters D₁, D₂, . . . D_{N} to emit at different wavelengths according to one or more defined sequences.

The spectral analysis surveillance system 500 includes a number of sensors S₁, S₂, . . . , S_{N} operable to sense a response (e.g., reflected, refracted, fluoresced or otherwise returned) to the emission or excitation by the sources or emitters D₁, D₂, . . . , D_{N}. Some examples of suitable sensors S₁, S₂, . . . , S_{N} have been previously described. One or more multiplexers MUX₄ (only one illustrated) may be responsive to control signal C₄ to sample output or data from selected ones of the sensors S₁, S₂, . . . , S_{N}.

The spectral analysis surveillance system 500 may employ other numbers of sensors S₁, S₂, . . . , S_{N}, and/or multiplexers MUX₄, as well as other arrangements of such components to implement a detection subsystem 514. The detection subsystem 514 may take a large variety of forms depending on a variety of conditions or factors, for example depending on the number and/or type of sensors S₁, S₂, . . . , S_{N}. The detection subsystem 514 may, for example, take the form of, or include, a PCL, PGA, ASIC, microcontroller, microprocessor and/or DSP, and/or associated non-transitory storage media (e.g., memory). The detection subsystem 514 may be configured to selectively receive and/or preprocess images or signals or other data produced by the sensors S₁, S₂, . . . , S_{N}. For example, where sensors S₁, S₂, . . . , S_{N} include analog video cameras, the detection subsystem 514 may include or implement a frame grabber. Frame grabbing may by synchronized or correlated with the emissions by the sources or emitters D₁, D₂, . . . , D_{N}. Where sensors S₁, S₂, . . . , S_{N} include digital still cameras or digital video cameras, the detection subsystem 514 may sample the digital image data or signals produced by the cameras. The digital image data or signals may be synchronized or correlated with the emissions by the sources or emitters D₁, D₂, . . . , D_{N}. For example, sampling may occur a defined time after a given emission to implement or facilitate correlation between emissions and responses. Where sensors S₁, S₂, . . . , S_{N} include photodiodes or similar devices, the detection subsystem 514 may sample the analog or digital output signal indicative of a magnitude of response detected by the photodiode(s). The analog or digital output signal may be synchronized or correlated with the emissions by the sources or emitters D₁, D₂, . . . , D_{N}.

The spectral analysis surveillance system 500 includes a control subsystem 516. The control subsystem 516 may take a variety of forms, for example the form illustrated in FIG. 5.

The control subsystem 516 may include a controller, for example one or more microcontrollers, microprocessors 518a, DSPs 518b, PGAs, ASICs, and/or PCLs (collectively 518).

The control subsystem 516 may include one or more non-transitory storage media (e.g., memory), for example nonvolatile memory such as Flash memory or read only memory (ROM) 520a and/or volatile memory such as random access memory (RAM) 520b (collectively 520). The non-transitory storage media 520 may store instructions executable by the controller(s) 518, and/or data, which causes the controller(s) 518 to operate the spectral analysis surveillance system 500. Such may include generating or receiving sequences for operating the sources or emitters D₁, D₂, . . . , D_{N}, for example sequences of wavelengths of emission. Such may optionally include correlating received responses with emission, and/or processing correlated responses with references to automatically analyze or assess people and other objects in a space under surveillance.

The control subsystem 516 may include one or more analog-to-digital converters (ADCs) 522 to convert analog signals to digital signals. Such may be employed, for example, where analog signals are being provided to the control subsystem 516 directly from analog sensors or from other surveillance systems.

The control subsystem 516 may include one or more communications ports, for example parallel ports 524a and/or serial ports 524b (collectively 524) to provide communications with other components of the spectral analysis surveillance system 500, other surveillance systems and/or an integrated surveillance system. Such ports 524 may, for example, allow for networked (e.g., TCP/IP, UDP/IP, ETHERNET) and/or non-networked (e.g., Universal Serial Bus or USB, FIREWIRE) communications. The control subsystem 516 may include suitable communications controllers (not shown) to implement communications.

The control subsystem 516 may additionally include one or more buffers 526. The buffer(s) 526 may be communicatively coupled to buffer data or information received via ADCs, parallel ports, and/or serial ports. For example, the buffer(s) 526 may buffer data received from sensors S₁, S₂, . . . , S_{N} while awaiting processing (e.g., correlation, analysis) by the controller(s) 518.

The various components of the control subsystem 516 may be coupled by one or more buses, collectively illustrated as 528. The buses 528 may, for example, include one or more power buses, instruction buses, address buses, data buses, and/or communications buses.

The spectral analysis surveillance system 500 may include a power supply 530 that receives electric power via a power source (not shown). The power source may take a large variety of forms. For example, the power source may be a source of alternating current (AC), for example a line or grid that supplies alternating current at 60 Hz commonly found in residential sites and commercial facilities. Alternatively, the power source may be a source of direct current (DC), for example one or more chemical batteries, arrays of super- or ultra-capacitors or ultracapacitors, and/or fuel cells.

The power supply 530 may take any of a variety of forms, dependent on the power source and the various components of the spectral analysis surveillance system 500 which receive power from the power supply 530. While illustrated as a single power supply 530, the spectral analysis surveillance system 500 may employ two or more power supplies, for example respective power supplies for power buses of different voltages (e.g., 12V, 5V, 3.5V) and/or associated systems or subsystems. The power supply 530 may include one or more rectifiers (not shown) that rectify AC power to DC power. The power supply 530 may include one or more DC/DC power converters (not shown), for example switch mode power converters such as buck converters, boost converters, buck-boost converters, or flyback converters, that step up and/or step down a voltage of DC power. The power supply 530 may include one or more alternators (not shown) that invert DC power to AC power. The power supply 530 may include one or more rectifiers (not shown) that rectify AC power to DC power. The power supply 530 may include one or more power conditioning circuits (not shown) which condition power, for example conditioning a line voltage to a cleaner form for use with the electronics of the spectral analysis surveillance system 500.

The sources and emitters D₁, D₂, . . . D_{N}, programmable current sources, and/or associated multiplexers MUX₁, MUX₂, MUX₃ may be carried by one or more circuit boards or other substrates 532. The sensors S₁, S₂, . . . S_{N} and associated multiplexer(s) MUX₄ may be carried by one or more circuit boards or other substrates 534, which may be different from the circuit board or substrates 532 which carry the sources or emitters D₁, D₂, . . . D_{N}. Alternatively, the sensors S₁, S₂, . . . S_{N} and associated multiplexer(s) MUX₄ may carried by the one or more circuit boards or substrates 532 that carry the sources and emitters D₁, D₂, . . . D_{N}. The control subsystem 516 may be carried by one or more circuit boards or other substrates 536, which may be different from the circuit board or substrates 532 which carry the sources or emitters D₁, D₂, . . . D_{N} or the circuit board or substrates 534 which carry the sensors S₁, S₂, . . . S_{N}. Alternatively, the control subsystem 516 may be carried by the one or more circuit boards or other substrates 536 which carry the sources or emitters D₁, D₂, . . . D_{N} or the circuit board or substrates 534 which carry the sensors S₁, S₂, . . . S_{N}.

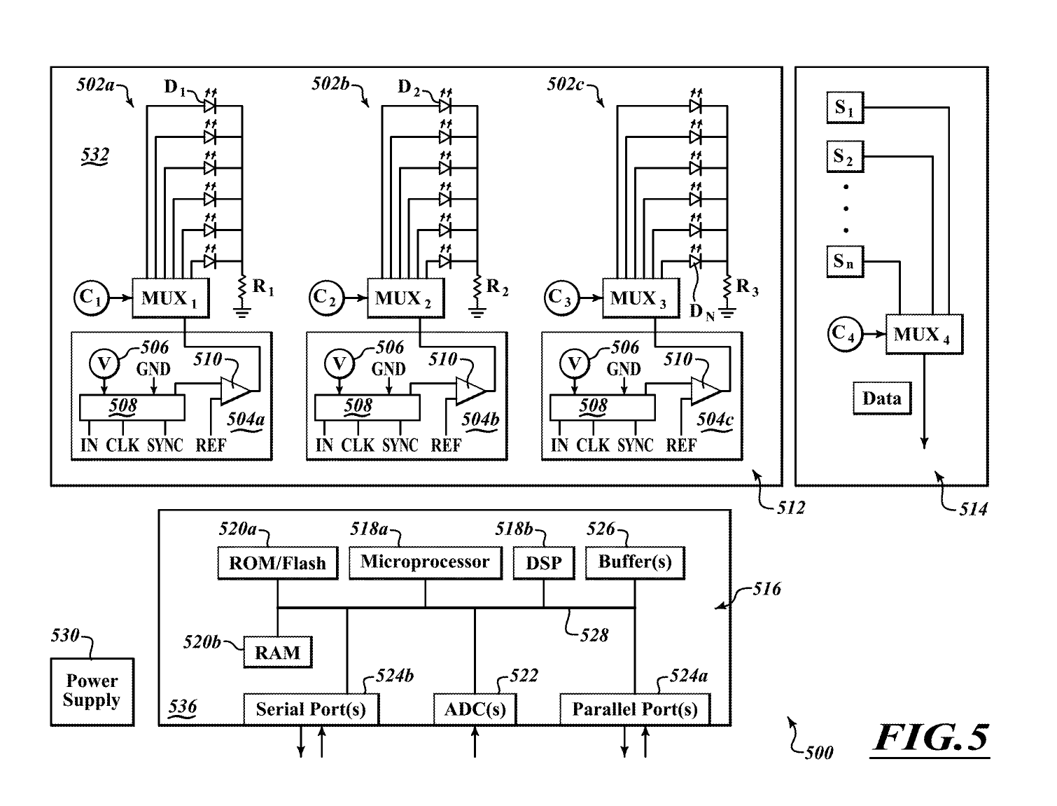

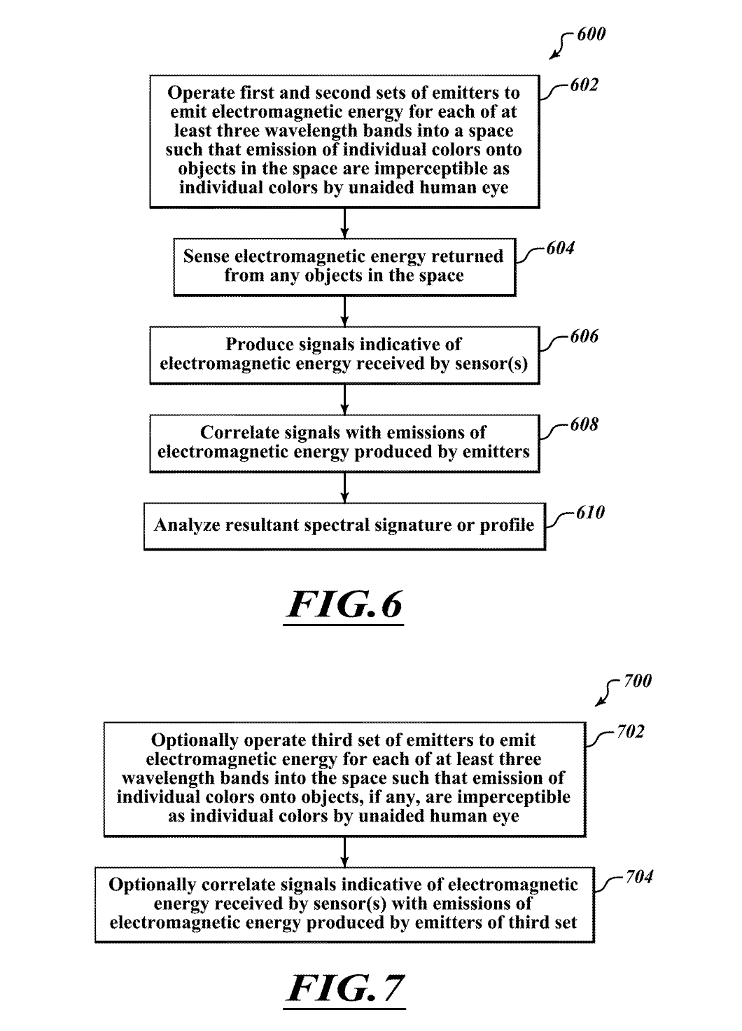

FIG. 6 shows a method 600 of operating a spectral analysis surveillance system portion of an integrated surveillance system, according to one illustrated embodiment.

At 602, at least one controller of the spectral analysis surveillance system operates first and second sets of sources or emitters to emit electromagnetic energy for each of at least three wavelength bands into a space such that emission of individual colors onto objects in the space are imperceptible as individual colors by the unaided human eye.

As described above, the sets of sources or emitters may take the form of LEDs or other sources or emitters of wavelengths of electromagnetic radiation. Also as described above, the sets of sources or emitters may be positioned or located spaced relatively apart from one another. For example, the sets of sources or emitters may be positioned partially across the space that is under surveillance, or even diametrically opposed across the space. Also for example, the sets of sources or emitters may be angled with respect to each other. The positioning of sets of sources or emitters relative to one another may be in two-dimensional space, for example on opposing walls. Additionally, or alternatively the positioning of sets of sources or emitters relative to one another may be in three-dimensional space, for example on a wall and on a ceiling or on adjacent walls where the surfaces are perpendicular to one another. The positioning of sets of sources or emitters spaced apart from and/or angled with respect to one another may advantageously provide illumination of different portions of an object and/or illumination from different angles.

The at least one controller may apply control signals to a power supply or emitter drive circuit which cause sources or emitters to emit electromagnetic radiation at one or more respective wavelengths. The control signals may take a variety of forms, for example digital or analog signals. The control signals may, for example, take the form of pulse width modulated signals. The control signals should be synchronized between the sets of sources or emitters to achieve the desired emission.

For example, a controller or control subsystem may drive the physical sources or emitters in a selected sequence with an electromagnetic forcing function. A physical source emits electromagnetic energy when driven by the electromagnetic forcing function. The controller or control subsystem may drive the physical sources or emitters via the driver electronics. The driver electronics may include any combination of switches, transistors and multiplexers, as known by one of skill in the art or later developed, to drive the physical sources or emitters in a selected drive pattern. The electromagnetic forcing function may be a current, a voltage and/or duty cycle. For example, a forcing function may be a variable current that drives one or more of the physical sources or emitters in the selected drive pattern (also referred to as a selected sequence). The controller or control subsystem may, for instance, drive the physical sources or emitters, or any subset thereof, in the selected sequence, in which only one or zero physical sources are being driven at any given instant of time. Alternatively, the controller or control subsystem may drive two or more physical sources of the physical sources or emitters at the same time for an overlapping time period during the selected sequence. The controller or control subsystem may operate automatically, or may be responsive to input from a user. Use of the electromagnetic forcing function to drive the physical sources or emitters as a number of logical or virtual sources or emitters to increase the number of wavelengths and combinations thereof is discussed in further detail herein.

A variety of approaches to achieving emission of individual colors that are imperceptible as individual colors by the unaided human eye are discussed below with reference to FIGS. 6-16. For example, sources or emitters may be operated in combinations (e.g., triplets) where each member or each group of members of the combination emits in a respective band (e.g., red band, blue band, green band) of visible light to achieve a combined output which is perceived as either a single color or white light. As described in more detail herein, the at least one controller may operate the members of the combination to emit substantially concurrently so that electromagnetic radiation in the respective bands are emitted concurrently or overlapping. Alternatively, as described in more detail herein, the at least one controller may operate the sources or emitters successively, at a frequency that is sufficiently high that the individual emissions are not perceived as respective colors. Such frequency should also be sufficiently high as to not trigger seizures in people prone to seizures. Each combination may be formed of sources or emitters all from the same set of sources or emitters. Thus, a combination may be formed by two or more sources or emitters which are collocated with respect to one another, for example carried on a common circuit board or panel. Each combination may be formed of sources or emitters from two or more different sets of sources or emitters. Thus, a combination may be formed by one or more sources or emitters at a first location, for example which are carried by a first circuit board or panel, and by one or more sources or emitters at a second location, for example which are carried by a second circuit board or panel, different from the first.

At 604, one or more sensors of the spectral analysis surveillance system sense electromagnetic energy returned from any objects in the space. The sensors may not themselves be capable of spectrally differentiating between various wavelengths of returned electromagnetic energy, however correlation with the wavelengths of emission allows spectral analysis to be performed.

At 606, one or more sensors of the spectral analysis surveillance system produce signals indicative of electromagnetic energy received by sensor(s). The signals may, for example, be indicative a level or intensity of returned electromagnetic energy. The signals may be digital signals. ADCs may be employed where the sensors produce analog signals. The signals may be provided to at least one controller of the spectral analysis surveillance system for correlation, and optionally for analysis. The at least one controller performing the correlation is typically collocated with the sensors and/or sources or emitters, although it may be remotely located therefrom. The at least one controller performing the analysis may be collocated with the sensors and/or sources or emitters, or may be remotely located therefrom.

At 608, the at least one controller of the spectral analysis surveillance system correlates the signals from the sensors with the emissions of electromagnetic energy produced by sources or emitters. There are a variety of approaches to correlating the signals indicative of the responses with the emissions, some of which have been described above. Typically, correlation will include a temporal correlation. That is, a signal indicative of a given response will be logically associated with one or more wavelengths of emission which produced the response based on timing. Such may be implemented by controlling the sources or emitters to provide a brief gap during which there is no emission between each successive emission. The gap should be sufficiently long as to ensure that the electromagnetic energy that is sensed by the sensors is the result of a given emission rather than a previous emission or a subsequent emission by the sources or emitters. Since the at least one controller is controlling the sources or emitters to emit in a defined sequence of wavelengths, the at least one controller matches the signals indicative of each received response with the most immediately preceding wavelength(s) of emission. It is noted that in some instances, two or more distinct wavelengths may be emitted substantially concurrently from respective sources or emitters. In those situations the correlation simply reflects the relationship between the signal indicative of the received response and the two or more wavelengths. Combinations of emission at two or more centerbands may increase the number of logical or virtual sources realizable by a given number of physical sources or emitters. Correlation may also include correlation with a pattern modulated in the emissions. For example, a pattern may be modulated into the emissions by varying a parameter of emission, for instance a level or magnitude (e.g., lumens) of emission. The at least one controller may analyze the signals indicative of the returned responses for the modulated pattern. Such may advantageously be employed to discern sensed electromagnetic energy produced in response to the emissions by the sources or emitters (i.e., responses) from ambient background electromagnetic energy, thereby increasing a signal-to-noise ratio of the system.

At 610, the at least one controller of the spectral analysis surveillance system analyzes the correlated signals from the sensors. For example, the at least one controller may compare the correlated signals, which may constitute a spectral signature or profile of the object in the space, with a reference set of data or information which may constitute a spectral signature or profile of a reference object. An algorithm for performing analysis is described in detail below, with reference to FIG. 15.

FIG. 7 shows a method 700 of operating a spectral analysis surveillance system portion of an integrated surveillance system, according to one illustrated embodiment. The method 700 may be useful in performing the method 600 (FIG. 6), for example the method 700 may be perform as a part thereof or in addition thereto.

At 702, at least one controller of the spectral analysis surveillance system optionally operates a third set of sources or emitters to emit electromagnetic energy for each of at least three wavelength bands into the space such that emission of individual colors onto the objects in the space, if any, are imperceptible as individual colors by the unaided human eye. Such may be performed in a similar manner to that described with reference to 602 of the method 600 (Figure), however with the at least one controller synchronizing between three or more sets of emitters.

At 704, at least one controller of the spectral analysis surveillance system operates to optionally correlate signals indicative of electromagnetic energy received by sensor(s) with emissions of electromagnetic energy produced by sources or emitters of the third set. As discussed above, there are a variety of approaches to correlating the sensed electromagnetic radiation with at least the wavelengths of the emitted electromagnetic radiation. The approaches discussed above may be applied to two, three or more sets of sources or emitters or wavelengths.

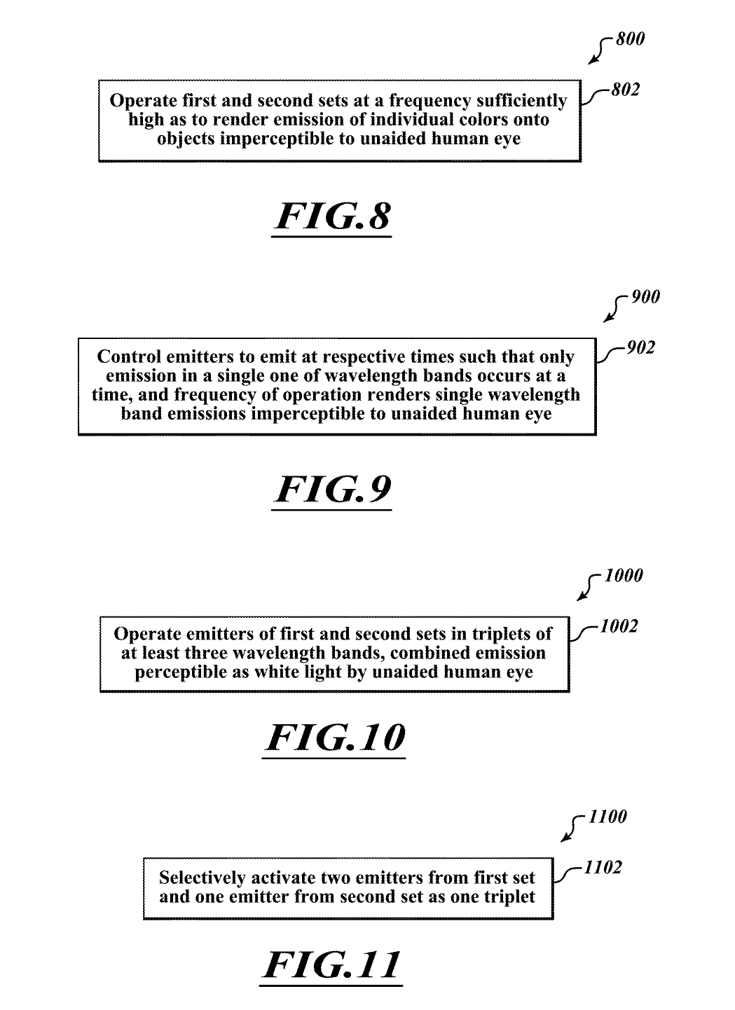

FIG. 8 shows a method 800 of operating a spectral analysis surveillance system portion of an integrated surveillance system, according to one illustrated embodiment. The method 800 may be useful in performing the method 600 (FIG. 6), for example in achieving an output that is not perceived as individual colors by humans.

At 802, at least one controller of the spectral analysis surveillance system operates at least first and second sets of sources or emitters at a frequency sufficiently high as to render emission of individual colors onto objects in the space imperceptible to the unaided human eye.

Human perception of light may be affected by combinations of specific wavelengths. Wavelengths of electromagnetic radiation of approximately 650 nm (e.g., 620 nm-700 nm) are perceived as red, while wavelengths of approximately 475 nm (e.g., 450-475) are perceived as blue and wavelengths of approximately 510 nm (e.g., 495 nm-570 nm) are perceived as green. However, the combination of wavelengths from approximately 400 nm to approximately 700 nm is perceived by humans as white light. Thus, sources or emitters that emit electromagnetic radiation at respective ones of a variety of different centerbands may be used to reduce or eliminate the perception of multiple individual colors. While the desired effect of reducing or eliminating the perception of multiple individual colors may be realized with two centerbands, typically combinations of three or more centerbands of emission will be employed. Those may include emission at one or more centerbands in the red band of visible light, emission at one or more centerbands in the blue band of visible light, and emission at one or more centerbands in the green band of visible light. It is noted that often the desired effect will be to achieve emission that is perceived substantially as white light, which has the advantage of rendering surveillance relatively undetectable, reducing the ability of mischievous people to avoid surveillance. However, in some implementations the desired effect may be to achieve emission that is perceived as a single color of light which is distinctly not white light, rather than two or more distinct colors of light. Such may have the advantage of emphasizing the existence of the surveillance, possibly serving as a deterrent to mischievous people, while simultaneously reducing the possibility of triggering frequency induced seizures.

FIG. 9 shows a method 900 of operating a spectral analysis surveillance system portion of an integrated surveillance system, according to one illustrated embodiment. The method 900 may be useful in performing the method 600 (FIG. 6), for example for example in achieving an output that is not perceived as individual colors by humans.

At 902, at least one controller of the spectral analysis surveillance system controls sources or emitters to emit at respective times such that only emission in a single one of the wavelength bands occurs at a time, and frequency of operation renders the single wavelength band emissions imperceptible to the unaided human eye. Thus, while electromagnetic radiation at only one centerband may be emitted at a time, the duration of emission is sufficiently short, and interleaved with emission of electromagnetic radiation at other centerbands, that the perceived effect is not of multiple colors. Rather the perceived effect may that of white light or a single color.

While the desired effect may be realized with two centerbands, typically three or more centerbands of emission (i.e., triplet) will be employed. Those centerbands may include emission at one or more centerbands in the red band of visible light, emission at one or more centerbands in the blue band of visible light, and emission at one or more centerbands in the green band of visible light. For example, emission may occur in a triplet pattern of R₁, B₁, G₁, which repeats, where R₁ indicates a first centerband in the red band, B₁ indicates a first centerband in the blue band, and G₁ indicates a first centerband in the green band of visible light. Also for example, emission may occur in a triplet pattern of R₁, B₁, G₁, R₂, B₂, G₂, which repeats, where R₂ indicates a second centerband in the red band, B₂ indicates a second centerband in the blue band, and G₂ indicates a second centerband in the green band of visible light. Patterns of emission at additional centerbands or other of the respective color bands of visible light may be employed. Notably, the order of emission does not need to be red, blue, green, and other orders (e.g., blue, red, green) may be employed. Additionally, the pattern may not immediately repeat. For instance, a pattern such as R₁, B₁, G₁, B₁, R₁, G₁ may be employed. Further, the pattern may not intentionally repeat. For example, the pattern may be a pseudo-random generated pattern generated by a pseudo-random number generator executing an algorithm designed to achieve a fairly random, yet even distribution of centerbands. While a pseudo-random approach will likely result in some occurrences of emission at a given centerband at two successive instances, the overall perception should be that of a lack of multiple different specific colors (e.g., white light). It is further noted that the drive signals may vary a duration or persistence of emission for any given centerband of emission (i.e., R₁ versus B₁), or even any given instance of emission (i.e., first instance of R₁, second instance of R₁) may vary. For example, the drive signals may account for differences in the persistence of phosphor material employed by certain LEDs to achieve emission of specific wavelengths. The drive signals may additionally, or alternatively account for differences in perception of different wavelengths by humans. Such may facilitate the ability to produce a combined emission that is perceived as a single color or as white light.

FIG. 10 shows a method 1000 of operating a spectral analysis surveillance system portion of an integrated surveillance system, according to one illustrated embodiment. The method 1000 may be useful in performing the method 600 (FIG. 6), for example in achieving an output that is perceived by humans as white light.

At 1002, at least one controller of the spectral analysis surveillance system operates sources or emitters of the first and second sets in triplets to emit electromagnetic radiation in at least three wavelength bands of the visible portion of the electromagnetic spectrum such that the combined emission perceptible as white light by the unaided human eye.

As discussed herein, the at least one controller selectively operates sources or emitters to emit electromagnetic radiation. Sources or emitters such as LEDs typically have a centerband of emission. The precise wavelength of the centerband may vary based on a number of parameters, for instance magnitude of drive current and temperature. The spectral analysis surveillance system may, for example, have a first number of sources or emitters that emit in a first band of the visible portion or band of the electromagnetic spectrum, a second number of sources or emitters that emit in a second band, and a third number of sources or emitters that emit in a third band. The at least one controller may operate the first set of sources or emitters which emit in the first band (e.g., red band or centerband in red band), the second set of sources or emitters that emit in the second band (e.g., blue band or centerband in blue band), and at least the third set of sources or emitters that emit in the third band (e.g., green band or centerband in green band). The three or more bands or centerbands may be selected to achieve a combined output that is perceived by humans as white light. Notably, combinations of red, blue and green emission can produce illumination that is perceived by humans as white light.

FIG. 11 shows a method 1100 of operating a spectral analysis surveillance system portion of an integrated surveillance system, according to one illustrated embodiment. The method 1100 may be useful in performing the method 600 (FIG. 6) and/or method 1000 (FIG. 10), for example using triplets of emitters in achieving an output that is perceived by humans as white light.

At 1102, at least one controller of the spectral analysis surveillance system selectively activates two sources or emitters from the first set and one emitter from the second set as one triplet.

As described above, each combination of three or more sources or emitters may be formed of sources or emitters from two or more different sets of sources or emitters. Thus, a combination may be formed by one source or emitter from a first set at a first location, for example which are carried by a first circuit board or panel, and by two or more sources or emitters of a second set at a second location, for example which are carried by a second circuit board or panel, different from the first. Due to the differences in positioning and/or angles of the sets of emitters with respect to one another, the use of emitters from two, or even more, sets advantageously results in a large number of additional combinations which may far exceed the number of physical sources or emitters, thus constituting additional logical or virtual sources or emitters.

For example, a first triplet formed of R₁ from a first set and B₁ and G₁ from the second set may be treated as a first logical or virtual source or emitter. A second triplet formed of B₁ and G₁ from the first set and R₁ from the second set will likely produce a distinctly different response than the first triplet and may be treated or regarded as a second logical or virtual source or emitter. A third triplet formed of R₁ and B₁ from the first set and G₁ from the second set will likely produce a distinctly different response than the first and second triplets and may be treated or regarded as a third logical or virtual source or emitter. A fourth triplet formed of R₁ and G₁ from the first set and B₁ from the second set will likely produce a distinctly different response than the first, second and third triplets and may be treated or regarded as a fourth logical or virtual source or emitter. Other combinations and permutations using the first and the second sets may likewise be employed to form even further logical or virtual sources or emitters. Where the spectral analysis surveillance system includes a third or more set of sources or emitters, further combinations and permutations using the first, second, third or more sets may likewise be employed to form yet further logical or virtual sources or emitters. Emission or excitation at a greater number of wavelengths or combination of wavelengths typically results in a more distinct spectral signature or profile, advantageously allowing more refined discrimination and/or higher levels of confidence in the result of analysis.

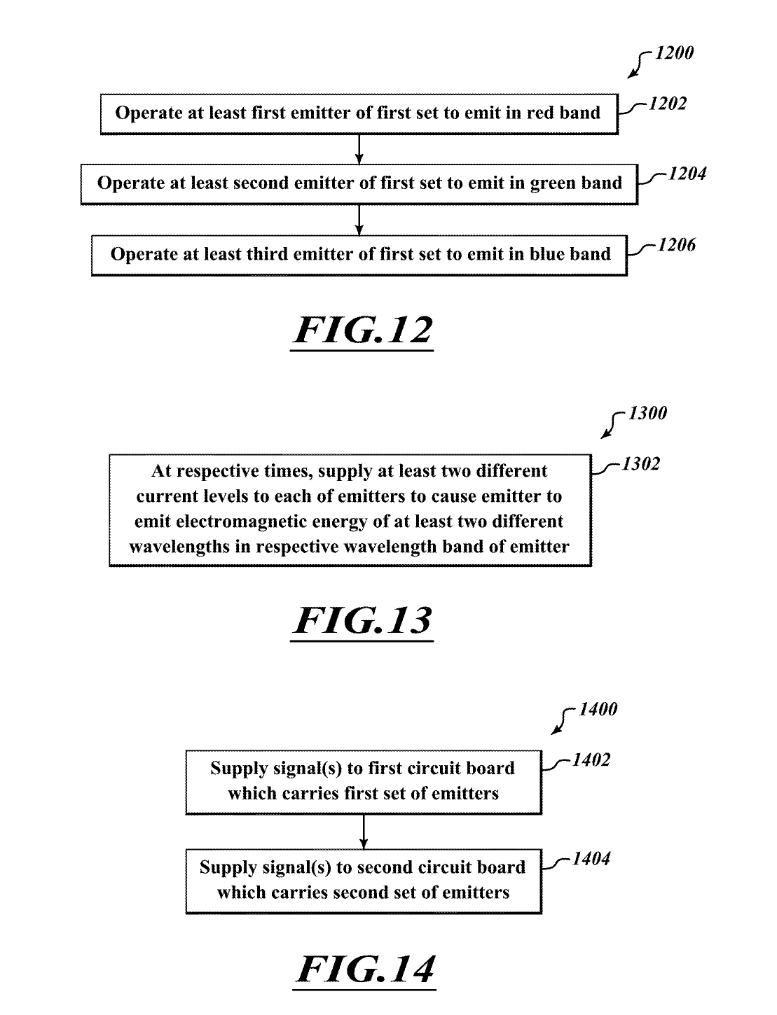

FIG. 12 shows a method 1200 of operating a spectral analysis surveillance system portion of an integrated surveillance system, according to one illustrated embodiment. The method 1200 may be useful in performing the method 600 (FIG. 6).

At 1202, at least one controller of the spectral analysis surveillance system operates at least a first source or emitter of a first set of sources or emitters to emit in a red band of the visible portion of the electromagnetic spectrum. For example, the at least one controller may cause a defined first level of a drive current to be supplied to the first source or emitter for a first duration. The drive current may compensate for temperature variation from a defined reference temperature. The compensation may further account for temperature induced wavelength of emission variation profile associated with the specific type of source or emitter. For example, the at least one controller may employ a mathematical relationship or a lookup table to adjust the drive current based on a sensed temperature.

At 1204, at least one controller of the spectral analysis surveillance system operates at least a second source or emitter of the first set of sources or emitters to emit in a green band of the visible portion of the electromagnetic spectrum. For example, the at least one controller may cause a defined second level of a drive current to be supplied to the second source or emitter for a second duration. As above, the drive current may compensate for temperature variation from a defined reference temperature and/or account for temperature induced wavelength of emission variation profile associated with the specific type of source or emitter.

At 1206, at least one controller of the spectral analysis surveillance system operates at a least third source or emitter of the first set of sources or emitters to emit in a blue band of the visible portion of the electromagnetic spectrum. For example, the at least one controller may cause a defined third level of a drive current to be supplied to the third source or emitter for a third duration. As above, the drive current may compensate for temperature variation from a defined reference temperature and/or account for temperature induced wavelength of emission variation profile associated with the specific type of source or emitter.

As described herein, the at least one controller may operate the sources or emitters in triplets to emit in either a concurrently or overlapping fashion, or successively at a frequency which is high enough to cause such emission to be perceived as white light.

FIG. 13 shows a method 1300 of operating a spectral analysis surveillance system portion of an integrated surveillance system, according to one illustrated embodiment. The method 1300 may be useful in performing the method 600 (FIG. 6).

At 1302, at least one controller of the spectral analysis surveillance system, at respective times, supplies at least two different current levels to each of the sources or emitters to cause an emitter to emit electromagnetic energy of at least two different wavelengths in the respective wavelength band of the emitter.

Sources or emitters such as LEDs typically have a nominal wavelength of emission which is commonly the centerband of emission. For many types of LEDs the centerband varies based on a number of parameters (e.g., drive current level or magnitude, temperature). Conventional drive circuits may, or may not, closely control drive current level. Conventional drive circuits may, or may not, compensate for temperature variation. When controlled, conventional drive circuits typically attempt to maintain a consistent centerband of emission over time, and often attempt to maintain a consistent level of output (e.g., Lumens) over time. Thus, conventional drive circuits are typically configured to provide a consistent level of drive current over time, as may be adjusted to account for temperature variation.

The at least one controller described herein may be configured to intentionally vary the centerband of emission of any one or more LEDs. Such may allow a single physical LED to act as two or more logical or virtual LEDs thereby producing a large variety of wavelengths than might otherwise be realized via a given number of LEDs.

FIG. 14 shows a method 1400 of operating a spectral analysis surveillance system portion of an integrated surveillance system, according to one illustrated embodiment. The method 1400 may be useful in performing the method 600 (FIG. 6).

At 1402, at least one controller of the spectral analysis surveillance system supplies signal(s) to a first circuit board which carries a first set of sources or emitters.

At 1404, at least one controller of the spectral analysis surveillance system supplies signal(s) to a second circuit board which carries a second set of sources or emitters.

As described herein, the first and second circuit boards may be spaced across at least a portion of the space from one another. For example, the first circuit board may have a major face that carries the first set of sources or emitters. The second circuit board may likewise have a major face that carries the second set of sources or emitters. The major face of the second circuit board may be angularly offset from the major face of the first circuit board such that a perpendicular axis to the major face of the second circuit board intersects with a perpendicular axis to the major face of the first circuit board. Angular offset of sources or emitters from one another may advantageously allow additional information to be discerned from an object.

As described herein, the signals may take any of a variety of forms suitable for driving the sources or emitters to emit. The drive signals may, for example, be supplied to a power supply to cause the power supply to apply drive current to the sources or emitters.

FIG. 15 shows a method 1500 of operating a spectral analysis surveillance system portion of an integrated surveillance system, according to one illustrated embodiment. The method 1500 may be useful in performing the method 600 (FIG. 6), for example in performing analysis.

Optionally at 1502, at least one processor determines a variety of thresholds that will be employed in the analysis. As described below, the at least one processor may analyze a variety of data, information, factors or parameters, and/or make a variety of determinations, comparisons and/or assessments based on a variety of data, information, factors or parameters in performing the analysis.

For example, the at least one processor may employ various processing techniques on the correlated signals (e.g., spectral signature or profile) to identify matches, degree of matching and/or corresponding objects.

Various thresholds may be employed in analyzing the data, information, factors or parameters. Some thresholds may be looser than others. Various thresholds may vary over time or may vary by location of the spectral analysis surveillance system. Thresholds may be predefined, fixed or may be variable and even adjustable in real-time or “on the fly” by authorized personnel. For example, in some installations or situations thresholds may be end user configurable. Adjusting thresholds provides ability to set filtering parameters, balancing over inclusiveness with under inclusiveness. Such may also inherently adjust speed of operation.

At 1504, the at least one processor may determine whether a match exists between the spectral signature or profile of the object in the space under surveillance and a spectral signature or profile of a reference object. As noted above, spectral signature or profile of the object in the space under surveillance may, for example, be the result of the correlation of the received responses with the emissions that elicited the received responses. Finding a match may not require finding an exact match. For example, one or more match related thresholds may be set to adjust the level of similarity required between the spectral signature or profile of the object and the spectral signature or profile of the reference to find a match. For instance, thresholds may be set to adjust the number of similarities or the degree of similarity required to cause the at least one processor which is comparing the spectral signatures to determine that a match exists.

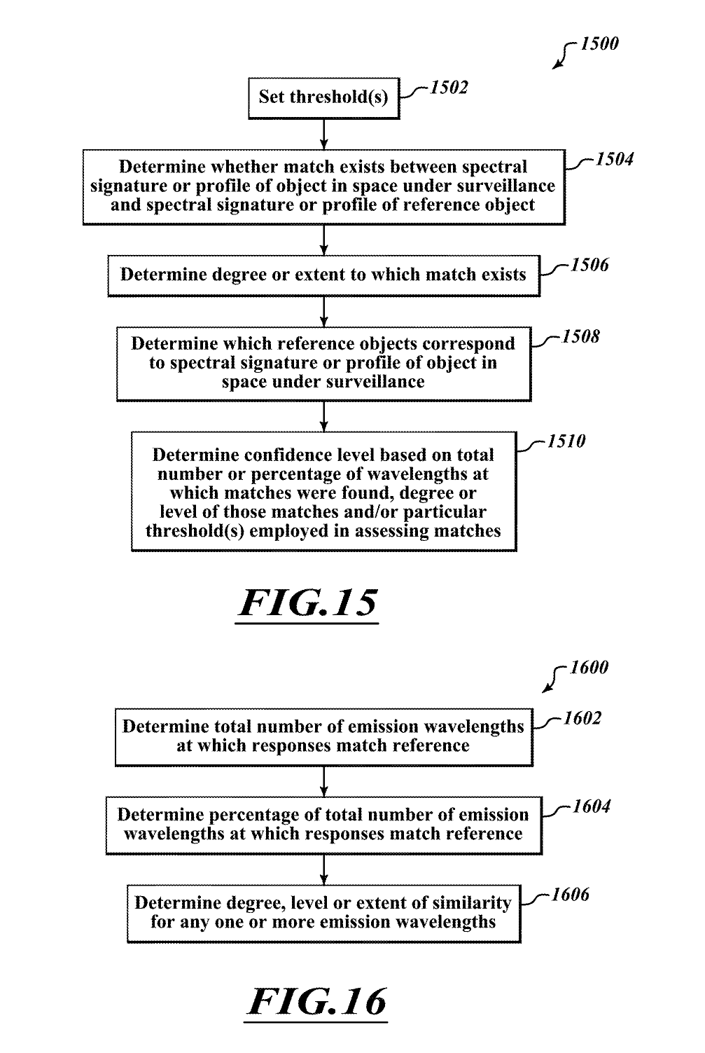

At 1506, the at least one processor may additionally, or alternatively, determine a degree or extent to which a match exists between the spectral signature or profile of the object in the space under surveillance and a spectral signature or profile of a reference object. An example of such is described below with reference to FIG. 16.

At 1508, the at least one processor may additionally, or alternatively, determine which of a number of reference objects correspond to the spectral signature or profile of the object in the space under surveillance. In many installations the object in the space is unknown, and it is desired to attempt to identify the object as part of the analysis. It may not be possible to uniquely identify the object in the space under surveillance with one type of object, but may be possible to provide a limited number of possible identities based on the analysis.

At 1510, the at least one processor may further determine a confidence level based on the number or percentage of wavelengths at which matches were found, the degree, level or extent of those matches (e.g., amount of similarity) and/or based on the particular threshold(s) employed in assessing those matches. A relatively high number of matches may increase the confidence level, while a relatively low number of matches may decrease the confidence level. A relatively high degree, level or extent of matching may increase the confidence level, while a relatively low degree, level or extent of matching may decrease the confidence level. Thresholds employed may serve as a proxy for degree, level or extent of matching. Various statistical techniques may be employed in assessing the degree, level or extent of matching and/or confidence level. The confidence level may be displayed to an end user and/or included in automatically generated reports.

FIG. 16 shows a method 1600 of operating a spectral analysis surveillance system portion of an integrated surveillance system, according to one illustrated embodiment. The method 1500 may be useful in performing the method 1500 (FIG. 15), for example in determining a degree, level or extent to which a match exists 1506.

At 1602, at least one processor may determine a total number of emission wavelengths at which a spectral signature or profile of an object in a space under surveillance (i.e., response) matches a spectral signature or profile of one or more reference objects. Digital comparisons of the spectral signatures or profiles may be performed using various techniques including curve fitting techniques. Typically, the larger the number of wavelengths at which matches or similarity is found, the higher the confidence level in the analysis or determination that a match either does, or does not, exist. Such dictates the sampling over a relatively large number of wavelengths or combinations of wavelengths, and hence the use of logical or virtual sources or emitters in addition to the physical sources or emitters.

At 1604, at least one processor may additionally, or alternatively, determine a percentage of the total number of wavelengths at which matches or similarities where found. Typically, the higher the percentage of total wavelengths at which matches or similarity is found, the higher the confidence level in the analysis or determination that a match either does, or does not, exist. Thus, even where a very high number of wavelengths is employed, if matches or similarity is found at a small percentage of those wavelengths, there will be little confidence in concluding that a match was found, while there may be high confidence in concluding that a match was not found.

At 1606, the at least one processor may additionally, or alternatively, determine a degree, level or extent of similarity between a spectral signature or profile of an object in a space under surveillance and a spectral signature or profile of a reference object at any one or more emission wavelengths. Any of a large variety of digital techniques or algorithms may be employed in determining a degree, level or extent of similarity, for example curve fitting algorithms and/or various statistical analysis packages.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other spectral based data collection systems, not necessarily the exemplary multispectral data collection systems generally described above.

Various methods and/or algorithms have been described. Some or all of those methods and/or algorithms may omit some of the described acts or steps, include additional acts or steps, combine acts or steps, and/or may perform some acts or steps in a different order than described.

Correlation generally refers to correlating a response with a particular emission or excitation. For example, where operating sources or emitters emit a sequence of wavelengths, correlation may include associating or logically associating one or more responses with a particular wavelength which caused the response. Correlation may account for other factors or parameters, for instance a magnitude of the emission. Correlation may be achieved based on a temporal relationship that is a response measured or otherwise detected a defined time after a given emission is correlated or associated with that given emission. More sophisticated techniques may be employed. For example, a pattern may be modulated onto the emissions, for instance a varying magnitude or intensity of emission. Correlation may include identifying the pattern in the responses and associating the responses with respective emissions based on the pattern of modulation.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of nontransitory signal bearing media used to actually carry out the distribution. Examples of nontransitory signal bearing media include, but are not limited to, the following: recordable type media such as floppy disks, hard disk drives, CD ROMs, digital tape, and computer memory.

The various embodiments described above can be combined to provide further embodiments. All of the commonly assigned US patent application publications, US patent applications, foreign patents, foreign patent applications and non-patent publications referred to in this specification and/or listed in the Application Data Sheet, including but not limited to:

U.S. provisional patent application Ser. No. 61/597,586, filed Feb. 10, 2012; U.S. provisional patent application Ser. No. 60/820,938, filed Jul. 31, 2006; U.S. patent application Ser. No. 12/375,814, filed Jan. 30, 2009; U.S. provisional patent application Ser. No. 60/834,662, filed Jul. 31, 2006; U.S. patent application Ser. No. 11/831,662, filed Jul. 31, 2007; U.S. Provisional Patent Application No. 60/890,446, filed Feb. 16, 2007; U.S. Provisional Patent Application No. 60/883,312, filed Jan. 3, 2007; U.S. Provisional Patent Application No. 60/871,639, filed Dec. 22, 2006; and U.S. Provisional Patent Application No. 60/834,589, filed Jul. 31, 2006; U.S. patent application Ser. No. 11/831,717, filed Jul. 31, 2007; and U.S. provisional patent application Ser. No. 61/538,617, filed Sep. 23, 2011 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A spectral analysis surveillance system, comprising:
a first set of a plurality of emitters positioned to emit electromagnetic energy into a space, the first set including a number of respective emitters for each of at least three wavelength bands of electromagnetic energy;
at least a second set of a plurality of emitters positioned to emit electromagnetic energy into the space including a number of respective emitters for each of at least three wavelength bands of electromagnetic energy, the second set spaced from the first set;
at least one sensor positioned to receive electromagnetic energy returned from any objects in the space and produce signals indicative of the received electromagnetic energy; and
a control subsystem that correlates the signals indicative of the electromagnetic energy received by the at least one sensor with the emissions of electromagnetic energy produced by the emitters of the first and second sets, and
wherein the emitters of the first and at least the second sets operate such that the emission of individual colors onto the objects in the space, if any, are imperceptible as individual colors by an unaided human eye.

2. The spectral analysis surveillance system of claim 1 wherein the emission of individual colors onto the objects in the space, if any, are perceptible as white light by the unaided human eye.

3. The spectral analysis surveillance system of claim 1 wherein the emitters of the first and at least the second sets are operated at a frequency sufficiently high as to render the emission of individual colors onto the objects in the space, if any, imperceptible to the unaided human eye.

4. The spectral analysis surveillance system of claim 1 wherein the emitters of each of the bands are controlled to emit at respective times such that only emission in a single one of the wavelength bands occurs at any respective time, and a frequency of operation renders the single wavelength band emissions imperceptible to the unaided human eye.

5. The spectral analysis surveillance system of claim 1 wherein the emitters of the first and at least the second sets are operated in triplets, each triplet including at least one emitter of each of the at least three wavelength bands, and the combined emission of the triplets is perceptible as white light by the unaided human eye.

6. The spectral analysis surveillance system of claim 5 wherein each triplet is formed by two emitters from the first set and one emitter from the second set.

7. The spectral analysis surveillance system of claim 5 wherein the wavelength bands of electromagnetic energy of the first set include a red band, a green band and a blue band.

8. The spectral analysis surveillance system of claim 1 wherein each of the emitters is operable to emit electromagnetic energy of a first wavelength at a first time and to emit electromagnetic energy in of a second wavelength at a second time, the second wavelength different than the first wavelengths and the first and the second wavelengths in the respective wavelength band of the emitter.

9. The spectral analysis surveillance system of claim 1 wherein a nominal wavelength of each of the wavelength bands of the emitters of the first set is the same as a nominal wavelength of each respective one of the wavelength bands of the emitters of the second set.

10. The spectral analysis surveillance system of claim 1 wherein the first set of emitters are carried by a first circuit board and the second set of emitters are carried by a second circuit board, the second circuit board spaced from the first circuit board.

11. The spectral analysis surveillance system of claim 1 wherein the first set of emitters are carried by a first circuit board and the second set of emitters are carried by a second circuit board, the second circuit board spaced across at least a portion of the space from the first circuit board.

12. The spectral analysis surveillance system of claim 1 wherein the first set of emitters are carried by a major face of a first circuit board and the second set of emitters are carried by a major face of a second circuit board, the major face of the second circuit board angularly offset from the major face of the first circuit board such that a perpendicular axis to the major face of the second circuit board intersects with a perpendicular axis to the major face of the first circuit board.

13. The spectral analysis surveillance system of claim 1, further comprising:
at least a third set of a plurality of emitters positioned to emit electromagnetic energy into the space, the third set including a number of respective emitters for each of at least three wavelength bands of electromagnetic energy, the third set spaced from the first and the second sets, and wherein the control subsystem correlates the signals indicative of the electromagnetic energy received by the at least one sensor with the emissions of electromagnetic energy produced by the emitters of the third set and the emitters of at least the third set operate such that the emission of individual colors onto the objects in the space, if any, are imperceptible as individual colors by the unaided human eye.

14. The spectral analysis surveillance system of claim 1 wherein the space is at least one of a room, an entry or corridor, defined by a number of walls, a ceiling and a floor and the emitters of at least one of the first or the second sets are mounted to at least one of the walls, ceiling or floor.

15. A method of operating a spectral analysis surveillance system, comprising:
operating a first set of a plurality of emitters to emit electromagnetic energy into a space, the first set including a number of respective emitters for each of at least three wavelength bands of electromagnetic energy;
operating at least a second set of a plurality of emitters to emit electromagnetic energy into the space including a number of respective emitters for each of at least three wavelength bands of electromagnetic energy, the second set spaced from the first set;
sensing by at least one sensor electromagnetic energy returned from any objects in the space;
producing by the at least one sensor signals indicative of the electromagnetic energy received by the least one sensor; and
correlating by a control subsystem the signals indicative of the electromagnetic energy received by the at least one sensor with the emissions of electromagnetic energy produced by the emitters of the first and second sets, and
wherein operating the first and at least the second sets includes operating the first and at least the second sets such that the emission of individual colors onto the objects in the space, if any, are imperceptible as individual colors by an unaided human eye.

16. The method of claim 15 wherein operating the first and at least the second sets includes operating the first and at least the second sets such that the emission of individual colors onto the objects in the space, if any, are perceptible as white light by the unaided human eye.

17. The method of claim 15 wherein operating the first and at least the second sets includes operating the first and at least the second sets at a frequency sufficiently high as to render the emission of individual colors onto the objects in the space imperceptible to the unaided human eye.

18. The method of claim 15 wherein operating the first and at least the second sets includes controlling the emitters to emit at respective times such that only emission in a single one of the wavelength bands occurs at a time, and a frequency of operation renders the single wavelength band emissions imperceptible to the unaided human eye.

19. The method of claim 15 wherein operating the first and at least the second sets includes operating the emitters of the first and at least the second sets in triplets, each triplet including at least one emitter of each of the at least three wavelength bands, and the combined emission of at least half of the triplets is perceptible as white light by the unaided human eye.

20. The method of claim 19 wherein operating the emitters of the first and at least the second sets in triplets includes selectively activating two emitters from the first set and one emitter from the second set as one of the triplets.

21. The method of claim 19 wherein operating a first set of a plurality of emitters to emit electromagnetic energy into a space includes operating at least a first emitter of the first set to emit in a red band, operating at least a second emitter of the first set to emit in a green band and operating at least a third emitter of the first set to emit in a blue band.

22. The method of claim 15 wherein operating the first and at least the second sets includes at respective times, supplying at least two different current levels to each of the emitters to cause the emitter to emit electromagnetic energy of at least two different wavelengths in the respective wavelength band of the emitter.

23. The method of claim 15 wherein operating a first set of a plurality of emitters includes supplying at least one signal to a first circuit board which carries the first set of emitters and operating a second set of a plurality of emitters includes supplying at least one signal to a second circuit board which carries the second set of emitters.

24. The method of claim 15 wherein operating a first set of a plurality of emitters includes supplying at least one signal to a first circuit board which carries the first set of emitters and operating a second set of a plurality of emitters includes supplying at least one signal to a second circuit board which carries the second set of emitters and which is spaced across at least a portion of the space from the first circuit board.

25. The method of claim 15 wherein operating a first set of a plurality of emitters includes supplying at least one signal to a first circuit board which has a major face that carries the first set of emitters and operating a second set of a plurality of emitters includes supplying at least one signal to a second circuit board which has a major face that carries the second set of emitters, the major face of the second circuit board angularly offset from the major face of the first circuit board such that a perpendicular axis to the major face of the second circuit board intersects with a perpendicular axis to the major face of the first circuit board.

26. The method of claim 15, further comprising:
operating at least a third set of a plurality of emitters to emit electromagnetic energy into the space, the third set including a number of respective emitters for each of at least three wavelength bands of electromagnetic energy, the third set spaced from the first and the second sets, wherein operating the emitters of at least the third set includes operating the emitters of the third set such that the emission of individual colors onto the objects in the space, if any, are imperceptible as individual colors by the unaided human eye; and
correlating by the control subsystem the signals indicative of the electromagnetic energy received by the at least one sensor with the emissions of electromagnetic energy produced by the emitters of the third set.

27. An integrated surveillance system, comprising:
at least one spectral analysis surveillance system, comprising: a first set of a plurality of emitters positioned to emit electromagnetic energy into a space, the first set including a number of respective emitters for each of at least three wavelength bands of electromagnetic energy; at least a second set of a plurality of emitters positioned to emit electromagnetic energy into the space including a number of respective emitters for each of at least three wavelength bands of electromagnetic energy, the second set spaced from the first set; at least one sensor positioned to receive electromagnetic energy returned from any objects in the space and produce signals indicative of the received electromagnetic energy; and a control subsystem that correlates the signals indicative of the electromagnetic energy received by the at least one sensor with the emissions of electromagnetic energy produced by the emitters of the first and second sets, and wherein the emitters of the first and at least the second sets operate such that the emission of individual colors onto the objects in the space, if any, are imperceptible as individual colors by an unaided human eye; and
at least one other surveillance system that does not emit electromagnetic energy in a visible portion of an electromagnetic spectrum.

28. The integrated surveillance system of claim 27 wherein the at least one other surveillance system includes at least one metal detector systems.

29. The integrated surveillance system of claim 27 wherein the at least one other surveillance system includes at least one full body imaging system which emits electromagnetic energy in at least one of the radio or the microwave portions of the electromagnetic spectrum.

30. The integrated surveillance system of claim 27 wherein the at least one other surveillance system includes at least one baggage screening which emits electromagnetic energy in at least one of the X-ray, radio or the microwave portions of the electromagnetic spectrum.
